(19) United States
(12) Patent Application Publication
(10) Pub. No.: US 2014/0065628 A1
(43) Pub. Date: Mar. 6, 2014

(54) Methods and Devices for Multi-Color, Out-of-Phase Detection in Electrophoresis

(71) Applicant: IntegenX Inc., Pleasanton, CA (US)

(72) Inventors: Ezra Van Gelder, Palo Alto, CA (US); Stephen J. Williams, San Carlos, CA (US)

(73) Assignee: IntegenX Inc., Pleasanton, CA (US)

(21) Appl. No.: 13/966,252

(22) Filed: Aug. 13, 2013

Related U.S. Application Data
(60) Provisional application No. 61/694,218, filed on Aug. 28, 2012.

(51) Int. Cl. G01N 27/447

(52) U.S. Cl. CPC G01N 27/44721; G01N 27/44791
USPC 435/6.12; 204/452; 204/603

(57) ABSTRACT

The disclosure provides methods and devices for separating and detecting nucleic acid fragments labeled with a plurality of spectrally resolvable dyes using a single light source or multiple light sources. Use of a greater number of light sources increases the number of spectrally resolvable dyes that can be interrogated. Labeling fragments with a greater number of spectrally resolvable dyes permits more overlapping of fragments with differentiation of the fragments, and thus separation can be conducted on a smaller range of fragment sizes/lengths. To improve the detection sensitivity of a detection system employing multiple light sources, light emitted by the light sources can be spatially separated from one another and/or the intensity of each of the light sources can be modulated. Each of the one or more light sources can be, e.g., a laser or a light-emitting diode. The methods and devices of the disclosure are useful for performing genetic analysis, e.g., analysis of a plurality of STR markers utilized in a forensic database (e.g., CODIS) to identify humans.

### BACKGROUND OF THE DISCLOSURE

In nucleic acid analysis, polymerase chain reaction (PCR) can be multiplexed by amplifying different regions of a single nucleic acid sample to produce amplified fragments of different sizes/lengths. Individual fragments can also be labeled with different dyes that fluoresce at distinct wavelengths. Information about an amplified sequence region is encoded by both the size/length of the amplified fragment and the color of the fluorescent dye used to label the fragment, and the two sources of information are independent of one another. Size/length-based separation of amplified nucleic acid fragments by gel electrophoresis and detection of separated dye-labeled fragments by laser-induced fluorescence enable identification of fragments based on size/length and color.

DNA profiling by short tandem repeat (STR) analysis is a multiplexed genetic analysis technique that uses fragment size/length and fluorescent labeling to provide a sensitive and parallel analysis of a number of different STR loci present in human genomic DNA. The Combined DNA Index System (CODIS) recommended by the Federal Bureau of Investigation (FBI) is currently based on 13 STR markers whose analysis enables identification of a human with a high probability of accuracy.

The present disclosure provides methods and devices for performing highly multiplexed genetic analyses using a greater number of labeling dyes in multiplex PCR amplifications. The disclosure provides detection systems that can excite a larger number of labeling dyes whose emission wavelengths span a broader range. For example, the disclosure provides multi-light source detection systems that can excite a larger set of labeling dyes, wherein light emitted by each of the light sources can be spatially separated from one another and the intensity of the light emissions of the light sources can be modulated to improve the sensitivity of detection of fluorescent signals. Use of the present methods and devices permits amplification of shorter lengths of dye-labeled nucleic acid fragments, which can improve the resolution of the fragments during separation, reduce the separation time, and enhance the recovery of genetic information from degraded nucleic acid samples.

### SUMMARY OF THE DISCLOSURE

The present disclosure provides methods and devices for separating and detecting nucleic acid fragments labeled with a plurality of spectrally resolvable dyes using a single light source or multiple light sources. Use of a greater number of light sources increases the number of spectrally resolvable dyes that can be interrogated. Labeling nucleic acid fragments with a greater number of spectrally resolvable dyes permits more overlapping of fragments with differentiation of the fragments, and thus separation can be conducted on a smaller range of fragment sizes/lengths. Shorter nucleic acid fragments can separate faster and with better resolution in electrophoresis, and can experience less degradation. For a detection system employing multiple light sources, noise from illumination of other light source(s) during illumination of a particular light source can be minimized by configuring each of the light sources to perform out-of-phase illumination. Out-of-phase illumination can be accomplished by spatially separating the light emissions of the light sources from one another by an appropriate distance and/or by modulating the intensity of each of the light sources at an appropriate frequency. For a detection system employing a single light source, modulation of the intensity of the light source can also be performed to extend the lifetime of the light source. A single light source or multiple light sources can have any of a variety of scanning and non-scanning configurations, as described herein. The methods and devices of the disclosure are useful for performing genetic analysis, e.g., analysis of a plurality of STR markers utilized in a forensic database (e.g., CODIS) to identify humans.

Some embodiments of the disclosure relate to a method of separating and detecting dye-labeled nucleic acid fragments using multiple light sources, which comprises:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

exciting the plurality of spectrally resolvable fluorescent dyes in each of the one or more separation channels separating a set of dye-labeled nucleic acid fragments produced from a sample with light emitted by a plurality of light sources, wherein each of the plurality of dyes is excited; and

detecting with a detector light emitted by each of the plurality of excited dyes in each of the one or more separation channels separating a set of dye-labeled nucleic acid fragments produced from a sample.

In some embodiments, light emitted by each of the light sources is spatially separated from one another, or light emitted by each of the light sources is spatially separated from light emitted by any of the other one or more light sources at any given time, or light emitted by each of the light sources is spatially separated from light emitted by every other light source. In certain embodiments, no two light sources illuminate the same point of any one of the one or more separation channels at a given time. In further embodiments, the interior of a given separation channel is illuminated by a single light source at a given time.

In certain embodiments, each of the light sources, or light emitted by each of the light sources, scans across each of the one or more separation channels. In further embodiments, each of the light sources is in the on mode when the light source scans across the interior of each separation channel, and each of the light sources is in the off mode when the light source scans across the exterior of each separation channel. In a scanning configuration of the light sources, the interior of a given separation channel can be illuminated by a single light source at a given time by spatially separating the light emissions of the light sources from one another by an appropriate distance and/or by modulating the intensity of each of the light sources at an appropriate frequency.

In other embodiments, in a non-scanning, non-staring configuration the light sources shine light across each of the one or more separation channels from one side or both sides of an array of one or more separation channels. In additional embodiments, in a non-scanning, staring configuration the light sources shine light at a mirror or lens at one side or both sides of an array of one or more separation channels, and the light from the light sources reflects off the mirror or lens across each separation channel. In a non-scanning, non-staring configuration or a non-scanning, staring configuration, in certain embodiments the light sources are intensity-modulated to be on at different times so that the interior of a given separation channel is illuminated by a single light source at a given time. In other embodiments, a different detector or sensor is locked onto the frequency of intensity modulation of each different light source, where each light source can have a scanning or non-scanning configuration.

Further embodiments of the disclosure are directed to a device for separating and detecting dye-labeled nucleic acid fragments using multiple light sources, which comprises:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a plurality of light sources configured to excite the plurality of spectrally resolvable fluorescent dyes in each of the one or more separation channels separating a set of dye-labeled nucleic acid fragments produced from a sample, wherein each of the plurality of dyes is excited; and

a detector configured to detect light emitted by each of the plurality of excited dyes in each of the one or more separation channels separating a set of dye-labeled nucleic acid fragments produced from a sample.

In some embodiments, each of the light sources emits light that is spatially separated from one another, or each of the light sources emits light that is spatially separated from light emitted by any of the other one or more light sources at any given time, or each of the light sources emits light that is spatially separated from light emitted by every other light source. In further embodiments, a single light source among the plurality of light sources illuminates the interior of a given separation channel at a given time. The light sources can have a scanning configuration or a non-scanning (e.g., non-scanning, non-staring or non-scanning, staring) configuration, and the intensity of the light sources may or may not be modulated, as described herein.

Additional embodiments of the disclosure relate to a method of separating and detecting dye-labeled nucleic acid fragments using a single light source, which comprises:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

exciting each of the plurality of spectrally resolvable fluorescent dyes in each of the one or more separation channels separating a set of dye-labeled nucleic acid fragments produced from a sample with light emitted by a single light source; and

detecting with a detector light emitted by each of the plurality of excited dyes in each of the one or more separation channels separating a set of dye-labeled nucleic acid fragments produced from a sample.

Further embodiments of the disclosure are drawn to a device for separating and detecting dye-labeled nucleic acid fragments using a single light source, which comprises:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a single light source configured to excite each of the plurality of spectrally resolvable fluorescent dyes in each of the one or more separation channels separating a set of dye-labeled nucleic acid fragments produced from a sample; and

a detector configured to detect light emitted by each of the plurality of excited dyes in each of the one or more separation channels separating a set of dye-labeled nucleic acid fragments produced from a sample.

With respect to both the method and the device for separating and detecting dye-labeled nucleic acid fragments using a single light source, the light source can have a single output wavelength or a single light emission of a relatively narrow bandwidth which excites a plurality of spectrally resolvable dyes, or multiple (e.g., two) output wavelengths or light emissions of a relatively narrow bandwidth which each excite one or more spectrally resolvable dyes. If the light source has a single output wavelength or a single light emission of a relatively narrow bandwidth, the light source can have a scanning configuration or a non-scanning (e.g., non-scanning, non-staring or non-scanning, staring) configuration, and the intensity of the light source can be modulated, as described herein. If the light source has multiple (e.g., two) output wavelengths or light emissions of a relatively narrow bandwidth which each excite one or more spectrally resolvable dyes, the light source can also have a scanning configuration or a non-scanning (e.g., non-scanning, non-staring or non-scanning, staring) configuration, and the interior of a given separation channel can be illuminated by a single output wavelength or a single light emission of a relatively narrow bandwidth at a given time through modulation of the intensity of the output wavelengths or light emissions or through utilization of appropriate filters, as described herein. In some embodiments, the light source having one or multiple (e.g., two) output wavelengths or light emissions scans across the interior of each of the one or more separation channels in the on mode and scans across the exterior of each separation channel in the off mode. In other embodiments, a different detector or sensor is locked onto the frequency of intensity modulation of each different output wavelength or each different light emission of a relatively narrow bandwidth from the light source, where the light source can have a scanning or non-scanning configuration.

In some embodiments, each of the one or more light sources outputs one or more light emissions of a relatively narrow bandwidth, e.g., no more than ±about 30, 25, 20, 15, 10, 5, 3 or 1 nm of the selected output wavelength or the maximum output wavelength of a given light emission. In certain embodiments, each of the one or more light sources is a laser, a light-emitting diode, a lamp with a relatively narrow filter that transmits light of a relatively narrow bandwidth, or a flash lamp with a relatively narrow filter that transmits light of a relatively narrow bandwidth. In an embodiment, each of the one or more light sources is a laser.

The methods and devices of the disclosure are further described below.

### BRIEF DESCRIPTION OF THE DRAWINGS

A better understanding of features and advantages of the present disclosure will be obtained by reference to the following detailed description, which sets forth illustrative embodiments of the disclosure, and the accompanying drawings.

FIG. 1 illustrates an embodiment of out-of-phase illumination of only the interior of capillaries by two scanning light sources (e.g., lasers) whose light emissions are spatially separated from one another and whose intensity is modulated.

FIG. 2 shows profiles of intensity modulation of light sources (e.g., lasers) for out-of-phase illumination of the interior of capillaries by two light sources having a non-scanning, staring configuration.

FIG. 3 illustrates an embodiment of illumination of only the interior of capillaries by a single scanning light source (e.g., a laser) whose intensity is modulated.

### DETAILED DESCRIPTION OF THE DISCLOSURE

While various embodiments of the present disclosure are described herein, it will be obvious to those skilled in the art that such embodiments are provided by way of example only. Numerous modifications and changes to, and variations and substitutions of, the embodiments described herein will be apparent to those skilled in the art without departing from the disclosure. It is understood that various alternatives to the embodiments described herein may be employed in practicing the disclosure. It is further understood that every embodiment of the disclosure may optionally be combined with any one or more of the other embodiments described herein which are consistent with that embodiment.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

The term “exemplary” as used herein means “serving as an example, illustration or instance”. Any embodiment characterized herein as “exemplary” is not necessarily to be construed as preferred or advantageous over other embodiments.

Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values. In certain embodiments, the term “about” or “approximately” means within 10% or 5% of the specified value.

Whenever the term “at least” precedes the first numerical value in a series of two or more numerical values, the term “at least” applies to each one of the numerical values in that series of numerical values.

The term “sample” refers to a sample containing biological material. A sample can be, e.g., a fluid sample (e.g., a blood or semen sample) or a tissue sample (e.g., a buccal swab). A sample can be a portion of a larger sample. A sample can be a biological sample comprising a nucleic acid (e.g., deoxyribonucleic acid (DNA), ribonucleic acid (RNA) or a variant of DNA or RNA) and/or a protein or polypeptide. A sample can be a forensic sample or an environmental sample. In some embodiments, a sample is not used as a control. In certain embodiments, the term “sample” does not include a positive control, a negative control, an allelic ladder or a size standard.

The present disclosure provides methods and devices for performing highly multiplexed genetic analyses using a greater number of labeling dyes in multiplex PCR amplifications. Increasing the number of labeling dyes used in a multiplex PCR amplification permits more overlap of dye-labeled nucleic acid fragments during separation (e.g., by electrophoresis), which has benefits. As an exemplary benefit, a greater number of genetic loci can be amplified in a single PCR amplification and analyzed, which decreases the probability of a random match and is useful in certain applications (e.g., kinship analysis). As another exemplary benefit, for a given number of genetic loci amplified, the range of fragment size/length of amplified products (also called amplicons) can be decreased. As an illustration, in DNA profiling by STR analysis, the amplified sequence of many alleles contains the repeat STR sequence plus a significant portion of the adjacent non-repeat DNA sequences. For example, the amplicons generated using the PowerPlex® 16 STR kit (Promega Corporation, Madison, Wis.) span a fragment size/length range from about 106 bases (for single-stranded fragments)/106 base pairs (bp) (for double-stranded fragments) to about 474 bases (for single-stranded fragments)/474 bp (for double-stranded fragments), while the repeat sequences of the STR loci themselves span from about 12 bases (for single-stranded fragments)/12 bp (for double-stranded fragments) to about 186 bases (for single-stranded fragments)/186 bp (for double-stranded fragments). Inclusion of adjacent non-repeat DNA sequences in the amplified fragments is designed to space the fragments suitably for electrophoretic separation.

The methods and devices of the disclosure permit use of a greater number of dyes for labeling nucleic acid fragments, which allow for more overlapping of fragments with differentiation and reduction in the size/length range of amplified fragments. Fragments that have the same size/length and migrate with the same electrophoretic mobility can be distinguished from one another only if they are labeled with spectrally resolvable dyes having different emission wavelengths. If a smaller number of spectrally resolvable dyes is employed, the size/length range of amplified fragments may need to be increased, particularly when a larger number of genetic loci is amplified in a single amplification, to avoid having fragments labeled with the same dye overlap during separation. By permitting use of a greater number of dyes, the present methods and devices allow for more overlapping of fragments labeled with spectrally resolvable dyes and reduction in the size/length range of amplified dye-labeled fragments. Amplicons of reduced size/length can be generated, e.g., by moving the forward and reverse PCR primers closer to the target genetic region (e.g., STR repeat region).

Generation of amplicons of reduced size/length has benefits. For example, recovery of genetic information from degraded DNA samples can be enhanced by amplifying shorter fragments. As another example, shorter fragments separate more rapidly in electrophoresis, thereby reducing the separation time. As a further example, resolution of closely spaced fragment sizes/lengths improves as fragment size/length decreases.

In some embodiments, the present disclosure permits use of a greater number of spectrally resolvable dyes for labeling nucleic acid fragments by employing a plurality of light sources in detection of dye-labeled fragments undergoing separation by electrophoresis. Each of the plurality of light sources can have a single output wavelength or a single light emission of a relatively narrow bandwidth, or multiple (e.g., two) output wavelengths or light emissions of a relatively narrow bandwidth. At least one of the output wavelength(s) or light emission(s) of a relatively narrow bandwidth of each of the light sources is designed to excite a certain set of dyes, where a set of dyes comprises one or more dyes excited by a particular output wavelength or light emission of a relatively narrow bandwidth. The light sources, and the sets of dyes, can be selected to have excitation wavelengths sufficiently far apart from one another so that illumination of a particular output wavelength or light emission of a relatively narrow bandwidth of a light source efficiently excites only the target set of dyes and not other set(s) of dyes. Furthermore, the dyes are selected to have distinct emission maxima sufficiently separated from one another so that an individual dye's contribution to the overall signal collected can be determined during spectral deconvolution. Employment of a greater number of light sources in electrophoresis detection enables excitation of a greater number of spectrally resolvable dyes and across a wider range of wavelengths.

Using lasers for purposes of illustration, a laser-induced fluorescence detection system can employ a single laser that has a single excitation wavelength (e.g., about 488 nm) or two excitation wavelengths (e.g., about 488 nm and about 514 nm), or can employ multiple (e.g., two) lasers that have distinct excitation wavelengths (e.g., about 488 nm and about 532 nm). If dye-labeled fragments are illuminated simultaneously by both wavelengths of the single laser or by the two wavelengths of the two lasers, detection of the fluorescent signals from the dyes becomes less sensitive because noise created by the lower frequency illumination is added to noise created by the higher frequency illumination.

To improve detection sensitivity, in some embodiments the present disclosure provides electrophoresis detection systems employing multiple light sources configured such that dye-labeled nucleic acid fragments in a given separation channel are illuminated by a single light source at any given time. The interior of a given separation channel can be illuminated by a single light source at a given time by spatial separation of the light emissions of the light sources from one another by an appropriate distance and/or by modulation of the intensity of the light sources at an appropriate frequency. In certain embodiments, modulation of the intensity of the light sources comprises scanning each of the plurality of light sources across the interior of each of the one or more separation channels in the on mode, and scanning each of the plurality of light sources across the exterior of each of the one or more separation channels in the off mode. An out-of-phase illumination strategy enables collection of signal from one or more dyes excited by the light source illuminating the interior of a given separation channel while eliminating noise from illumination of the other light source(s).

### Method and Device Employing Multiple Light Sources

Some embodiments of the disclosure relate to a method of separating and detecting dye-labeled nucleic acid fragments using a plurality of light sources, which comprises:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

exciting the plurality of spectrally resolvable fluorescent dyes in each of the one or more separation channels separating a set of dye-labeled nucleic acid fragments produced from a sample with light emitted by a plurality of light sources,
wherein each of the plurality of dyes is excited, and
wherein in some embodiments light emitted by each of the plurality of light sources is spatially separated from light emitted by any of the other light source(s) at any given time; and

detecting with a detector light emitted by each of the plurality of excited dyes in each of the one or more separation channels separating a set of dye-labeled nucleic acid fragments produced from a sample.

In certain embodiments, the electrophoresis system comprises one separation channel, and the method comprises separating one set of nucleic acid fragments labeled with a plurality of spectrally resolvable fluorescent dyes and produced from a sample.

In other embodiments, the electrophoresis system comprises a plurality of separation channels. In certain embodiments, the electrophoresis system comprises 4, 8, 16, 32, 48, 64, 80, 96, 112, 128 or more separation channels. In an embodiment, the electrophoresis system comprises 8 separation channels. In some embodiments, the electrophoresis system comprises a substantially planar array of the plurality of separation channels.

In further embodiments, the method comprises separating a plurality of sets of dye-labeled nucleic acid fragments produced from a plurality of samples, each such set of nucleic acid fragments labeled with a plurality of spectrally resolvable fluorescent dyes and produced from a different sample. In certain embodiments, the method comprises separating 2, 5, 13, 29, 45, 61, 77, 93, 109, 125 or more sets of dye-labeled nucleic acid fragments produced from 2, 5, 13, 29, 45, 61, 77, 93, 109, 125 or more samples, each such set of nucleic acid fragments labeled with a plurality of spectrally resolvable fluorescent dyes and produced from a different sample. In an embodiment, the method comprises separating 5 sets of dye-labeled nucleic acid fragments produced from 5 samples, each such set of nucleic acid fragments labeled with a plurality of spectrally resolvable fluorescent dyes and produced from a different sample.

Labeling each set of nucleic acid fragments produced from a sample with a plurality of spectrally resolvable fluorescent dyes permits more overlapping of fragments during separation with differentiation of the fragments. The dyes are selected to be spectrally resolvable, or spectrally distinguishable, from one another such that the fluorescence emission of a particular dye can be distinguished from that of all the other dye(s) used for labeling fragments in that set of dye-labeled fragments. For example, the dyes are selected to have distinct emission maxima sufficiently separated from one another so that an individual dye's contribution to the overall signal collected can be determined during spectral deconvolution. Fragments labeled with spectrally resolvable fluorescent dyes can be distinguished from one another based on their different fluorescence emissions even when the fragments have the same size/length and migrate with the same electrophoretic mobility.

In some embodiments, each set of nucleic acid fragments produced from a sample independently is labeled with at least 5 or 6 spectrally resolvable fluorescent dyes. In further embodiments, each set of nucleic acid fragments produced from a sample independently is labeled with 5, 6, 7, 8, 9, 10, 11, 12, 13, 14, 15, 16, 17, 18, 19, 20 or more spectrally resolvable fluorescent dyes. The greater the number of spectrally resolvable fluorescent dyes used for labeling fragments in a set, the more fragments can overlap with differentiation, and the smaller the range of fragment sizes/lengths is needed to space the fragments suitably for separation. In certain embodiments, each set of nucleic acid fragments produced from a sample independently is labeled with 7, 8, 9, 10 or 11 spectrally resolvable fluorescent dyes.

A nucleic acid fragment in a set of nucleic acid fragments produced from a sample can be labeled with one or more dyes. In certain embodiments, a nucleic acid fragment is labeled with one or more dyes toward or at the 5′ end of the fragment. In some embodiments, each of the plurality of spectrally resolvable fluorescent dyes labels a different nucleic acid fragment in each set of nucleic acid fragments produced from a sample.

In some embodiments, one or more nucleic acid fragments in a set of nucleic acid fragments produced from a sample are labeled with an energy-transfer dye pair. In an energy-transfer dye pair, one dye is excited by a light source and acts as a donor, and the other dye acts as an acceptor and emits a fluorescent signal. The emission wavelength of the dye pair can be tuned by varying the acceptor dye while keeping the donor dye constant. A constant donor dye permits a wavelength of light to excite an energy-transfer dye pair while the emission wavelength of the dye pair can be varied over a wider range by altering the acceptor dye. Labeling nucleic acid fragments with energy-transfer dye pairs can increase the number of distinct fluorescence emissions that can be detected while illuminating with a particular wavelength of light or with a particular light emission having a relatively narrow bandwidth. Non-limiting examples of energy-transfer dye pairs include 5- or 6-FAM/5- or 6-JOE, 5- or 6-FAM/5- or 6-TAMRA, 5- or 6-FAM/TMR, 5- or 6-FAM/5- or 6-ROX, 5- or 6-JOE/TOM, 3-(epsilon-carboxypentyl)-3′-ethyl-5,5′-dimethyloxacarbocyanine (CYA)/5- or 6-FAM, CYA/5- or 6-R6G, CYA/5- or 6-ROX, CYA/5- or 6-TAMRA, 4′-aminomethyl-5 (or 6)-FAM/5- or 6-carboxy-R6G, and 4′-aminomethyl-5 (or 6)-FAM/5- or 6-carboxy-4,7-dichloro-R6G. CYA is a donor dye that can be excited with light having a wavelength of, e.g., about 488 nm, and 4′-aminomethyl-5 (or 6)-FAM is a donor dye that can be excited with light having a wavelength of, e.g., about 488 or 514 nm. In certain embodiments, a nucleic acid fragment labeled with an energy-transfer dye pair is labeled with the donor dye toward or at the 5′ end of the fragment.

Table 1 includes non-limiting examples of fluorescent dyes that can be used to label nucleic acid fragments.

TABLE 1

| | Approximate | Approximate |
|---|---|---|
| | Excitation | Emission |
| Fluorescent Dyes | Maximum (nm) | Maximum (nm) |
| Alexa 350 | 343 | 441 |
| Alexa 405 | 401 | 421 |
| Alexa 430 | 431 | 540 |
| Alexa 488 | 493 | 520 |
| Alexa 532 | 528 | 553 |
| Alexa 546 | 562 | 573 |
| Alexa 555 | 553 | 568 |
| Alexa 568 | 576 | 603 |
| Alexa 594 | 590 | 619 |
| Alexa 633 | 632 | 648 |
| Alexa 647 | 653 | 669 |
| Alexa 660 | 664 | 691 |
| Alexa 680 | 679 | 703 |
| Alexa 700 | 696 | 720 |
| Alexa Fluor 350, SE | 346 | 442 |
| Alexa Fluor 405, SE | 402 | 421 |
| Alexa Fluor 430, SE | 433 | 539 |
| Alexa Fluor 488 hydrazide-water | 493 | 518 |
| Alexa Fluor 488, SE | 492 | 517 |
| Alexa Fluor 532, SE | 527 | 553 |
| Alexa Fluor 546, SE | 555 | 571 |
| Alexa Fluor 594, SE | 584 | 616 |
| Alexa Fluor 647, SE | 650 | 670 |
| Alexa Fluor 660, SE | 661 | 691 |
| Alexa Fluor 750, SE | 753 | 775 |
| Alexa Fluor 610 R-phycoerythrin | 567 | 627 |
| streptavidin, pH 7.2 | | |
| Alexa Fluor 647 R-phycoerythrin | 569 | 666 |
| streptavidin, pH 7.2 | | |
| AMCA-X, SE | 353 | 442 |
| Atto 647 | 644 | 670 |
| Bimane (carboxy) | 380 | 458 |
| BODIPY 530/550, SE | 534 | 554 |
| BODIPY 558/568, SE | 558 | 569 |
| BODIPY 564/570, SE | 565 | 571 |
| BODIPY 576/589, SE | 576 | 590 |
| BODIPY 581/591, SE | 584 | 592 |
| BODIPY 630/650-X, SE | 625 | 640 |
| BODIPY 650/655-X, SE | 646 | 660 |
| BODIPY 650/665-X, MeOH | 646 | 664 |
| BODIPY FL conjugate | 503 | 512 |
| BODIPY FL, MeOH | 502 | 511 |
| BODIPY FL, SE | 505 | 513 |
| BODIPY FL, SSE | 505 | 513 |
| BODIPY FL-X, SE | 505 | 513 |
| BODIPY R6G, SE | 528 | 547 |
| BODIPY R6G, MeOH | 528 | 547 |
| BODIPY TMR, SE | 542 | 574 |
| BODIPY TMR-X conjugate | 544 | 573 |
| BODIPY TMR-X, MeOH | 544 | 570 |
| BODIPY TMR-X, SE | 544 | 570 |
| BODIPY TR, SE | 589 | 617 |
| BODIPY TR-X phallacidin, pH 7.0 | 590 | 621 |
| BODIPY TR-X, MeOH | 588 | 621 |
| BODIPY TR-X, SE | 588 | 621 |
| Carboxynaphthofluorescein (including | 600 | 674 |
| 5- or 6-isomer), pH 10.0 | | |
| Carboxynaphthofluorescein, SE | 602 | 672 |
| (including 5- or 6-isomer) | | |
| 5-CR (5-carboxyrhodamine) 6G, SE | 525 | 555 |
| 6-CR 6G, pH 7.0 | 526 | 547 |
| 6-CR 6G, HCl salt | 525 | 547 |
| Cascade Blue (acetyl azide) | 400 | 420 |
| Cy 2 | 489 | 503 |
| Cy 3 | 549 | 562 |
| Cy 3.5 | 578 | 591 |
| Cy 5 | 646 | 664 |
| Cy 5.5 | 673/685 | 692/706 |
| Dialkylaminocoumarin (carboxy or | 375/435 | 470/475 |
| SE) | | |
| 6,8-Difluoro-7-hydroxy-4- | 358 | 450 |
| methylcoumarin, pH 9.0 | | |
| Dy 750, SE | 747 | 776 |
| EvaGreen | 500 | 530 |
| 5-FAM (5-carboxyfluorescein), pH 9.0 | 492 | 518 |
| 5-FAM, SE | 494 | 518 |
| 5-FAM-EX, SE (EX is a seven-atom | 494 | 518 |
| spacer) | | |
| 6-FAM | 495 | 520 |
| 6-FAM (azide) | 496 | 516 |
| 6-FAM, SE | 496 | 516 |
| FAM-X, SE (including 5- or 6-isomer) | 494 | 518 |
| (X is an aminohexanoyl spacer | | |
| between dye and SE) | | |
| FITC | 495 | 517 |
| Fluorescein | 495 | 517 |
| Fluorescein dT | 495 | 520 |
| Fluorescein, pH 9.0 | 490 | 514 |
| Fluorescein, 0.1M NaOH | 493 | 513 |
| Fluorescein dextran, pH 8.0 | 501 | 524 |
| HEX | 538 | 555 |
| 6-HEX, SE, pH 9.0 | 534 | 559 |
| Hydroxycoumarin (carboxy or SE) | 385/360 | 445/455 |
| 5′ IRDye 700 | 684 | 702 |
| 5′ IRDye 800 | 791 | 809 |
| 5′ IRDye 800CW, SE | 767 | 791 |
| 6-JOE (6-carboxy-4′,5′-dichloro-2′,7′- | 520 | 548 |
| dimethoxyfluorescein) | | |
| 6-JOE, SE | 522 | 550 |
| JOE, SE | 529 | 555 |
| Lightcycler 640, SE | 620 | 635 |
| Lissamine rhodamine B, SC (including | 570 | 590 |
| 5- or 6-isomer) | | |
| Marina Blue, SE | 365 | 460 |
| MAX, SE | 524 | 557 |
| Methoxycoumarin (carboxy or SE) | 358 | 410 |
| Oregon Green 488 (including 5- or 6- | 498 | 526 |
| carboxy, and 5- or 6-SE) | | |
| Oregon Green 488-X, SE (including 5- | 498 | 526 |
| or 6-isomer) (X is an aminohexanoyl | | |
| spacer between dye and SE) | | |
| Oregon Green 514 (including 5- or 6- | 512 | 532 |
| carboxy, and 5- or 6-SE) | | |
| Pacific Blue, SE | 410 | 455 |
| Pacific Orange, SE | 400 | 551 |
| Rhodamine | 551 | 573 |
| Rhodamine 6G (R6G), SE (including | 525 | 555 |
| 5- or 6-isomer) | | |
| Rhodamine 110 | 497 | 520 |
| Rhodamine 110, pH 7.0 | 497 | 520 |
| Rhodamine B | 543 | 565 |
| Rhodamine Green | 497 | 524 |
| Rhodamine Green, SE (including 5- or | 502 | 527 |
| 6-isomer) | | |
| Rhodamine Green-X, SE (including 5- | 504 | 531 |
| or 6-isomer) (X is an aminohexanoyl | | |
| spacer between dye and SE) | | |
| Rhodamine Red-X, SE (including 5- or | 574 | 594 |
| 6-isomer) | | |
| ROX (carboxy-X-rhodamine) (5- or 6- | 578 | 604 |
| carboxy), pH 7.0 | | |
| ROX (5- or 6-carboxy), | 578 | 604 |
| triethylammonium salt | | |
| ROX, SE (5- or 6-SE) | 580 | 605 |
| SYBR Green I | 497 | 520 |
| Tetramethylrhodamine dextran, pH | 555 | 582 |
| 7.0 | | |
| TAMRA | 559 | 583 |
| (carboxytetramethylrhodamine) | | |
| TAMRA, SE | 559 | 583 |
| 5-TAMRA | 549 | 577 |
| 5-TAMRA, pH 7.0 | 553 | 576 |
| 5-TAMRA, MeOH | 543 | 567 |
| 5-TAMRA (azide) | 546 | 579 |
| 5-TAMRA, SE | 555 | 580 |
| 6-TAMRA | 555 | 580 |
| 6-TAMRA, SE | 555 | 580 |
| 5- or 6-TAMRA-X, SE (X is amino- | 555 | 580 |
| hexanoyl spacer between dye and SE) | | |
| TET | 522 | 539 |
| 6-TET, SE, pH 9.0 | 521 | 542 |
| TEX 615 | 596 | 613 |
| Texas Red, SC (including 5- or 6- | 595 | 615 |
| isomer) | | |
| Texas Red-X, SE (including 5- or 6- | 598 | 617 |
| isomer) (X is an aminohexanoyl spacer | | |
| between dye and SE) | | |
| TMR (tetramethylrhodamine) | 543 | 580 |
| TOM | 606 | 627 |
| TYE 563 | 549 | 563 |
| TYE 665 | 645 | 665 |
| TYE 705 | 686 | 704 |
| WellRED D2 dye | 763 | 778 |
| WellRED D3 dye | 683 | 701 |
| WellRED D4 dye | 648 | 666 |

BODIPY = a substituted 4,4-difluoro-4-bora-3a,4a-diaza-s-indacene derivative;
SC = sulfonyl chloride;
SE = succinimidyl (NHS) ester;
SSE = water-soluble sulfosuccinimidyl ester

An organic fluorescent dye typically has an excitation/absorption spectrum whose peak represents the excitation/absorption maximum, and an emission spectrum whose peak represents the emission maximum. The excitation spectrum and/or the emission spectrum, and the excitation maximum and/or the emission maximum, of a dye may vary depending on, e.g., the kind of salt of the dye used (if the dye can be a salt) and the pH of the environment. The dyes are selected to be spectrally resolvable, or spectrally distinguishable, from one another such that the fluorescence emission of one dye can be distinguished from that of all the other dye(s) used to label nucleic acid fragments in that set of dye-labeled fragments produced from a sample. In certain embodiments, a dye has an emission maximum that differs from that of all the other dye(s) used by at least about 10, 15, 20, 25, 30, 40 or 50 nm.

The method employs a plurality of light sources to excite the plurality of spectrally resolvable fluorescent dyes in each of the one or more separation channels separating a set of dye-labeled nucleic acid fragments produced from a sample. In certain embodiments, the plurality of light sources are 2, 3, 4, 5 or more light sources. In an embodiment, the plurality of light sources are two light sources. In some embodiments, each of the light sources emits light of a different wavelength. In certain embodiments, each of the light sources has an output wavelength differing from the output wavelength of all the other light source(s) used by at least about 50, 75, 100, 125, 150, 175 or 200 nm, or emits a relatively narrow spectrum of light having a selected output wavelength or a maximum output wavelength differing from the selected output wavelength or the maximum output wavelength of all the other light source(s) used by at least about 50, 75, 100, 125, 150, 175 or 200 nm. Each of the light sources can have a single output wavelength or a single light emission of a relatively narrow bandwidth, or a plurality of output wavelengths or a plurality of light emissions of a relatively narrow bandwidth. In certain embodiments, each of the light sources has a single output wavelength or a single light emission of a relatively narrow bandwidth, or two output wavelengths or two light emissions of a relatively narrow bandwidth.

Each of the plurality of light sources can emit coherent light or incoherent light. In an embodiment, each of the light sources emits coherent light. In certain embodiments, each of the light sources outputs one or more light emissions of a relatively narrow bandwidth, e.g., no more than ±about 30, 25, 20, 15, 10, 5, 3 or 1 nm of the selected output wavelength or the maximum output wavelength of a given light emission. Examples of light sources that can be used to excite fluorescent dyes include without limitation lasers (e.g., solid-state lasers and diode lasers), light-emitting diodes (e.g., organic LEDs, inorganic LEDs and quantum dot LEDs), lamps with a relatively narrow filter that transmits light of a relatively narrow bandwidth, and flash lamps with a relatively narrow filter that transmits light of a relatively narrow bandwidth. In an embodiment, each of the light sources is a laser. Non-limiting examples of lasers include the OBIS line of solid-state lasers (Coherent Inc., Santa Clara, Calif.), which provide a wide range of output wavelengths (e.g., about 375, 405, 445, 488, 514, 552, 637, 640, 647, 660, 685, 730 and 785 nm) and whose intensity can be modulated by analog or digital modulation.

The choice of light sources can depend on various factors, such as the excitation wavelengths of spectrally resolvable fluorescent dyes. Each of the light sources is selected to output one or more light emissions that excite a certain set of spectrally resolvable fluorescent dyes, where a set of spectrally resolvable fluorescent dyes comprises one or more spectrally resolvable fluorescent dyes excited by a particular light emission. The light sources, and the sets of spectrally resolvable fluorescent dyes, can be selected to have excitation wavelengths sufficiently far apart from one another so that a particular light emission of a light source efficiently excites only the target set of dyes and not other set(s) of dyes, to avoid photobleaching of the other set(s) of dyes during excitation of the target set of dyes. In certain embodiments, each of the light sources emits an output wavelength separated from, or emits a relatively narrow spectrum of light having a selected output wavelength or a maximum output wavelength separated from, the excitation maximum of the dye(s) not intended to be excited by that light source by at least about 20, 25, 30, 40, 50, 60, 70, 80, 90 or 100 nm. As a non-limiting example, two light sources can be used to efficiently excite 8 spectrally resolvable fluorescent dyes, where one light source efficiently excites a set of 4 spectrally resolvable fluorescent dyes and the other light source efficiently excites another set of 4 spectrally resolvable fluorescent dyes. To avoid photobleaching of the other set of dyes during excitation of the target set of dyes, the two light sources are selected to have sufficiently distinct output wavelengths or light emissions (e.g., about 488 nm and about 650 nm).

As an additional example of a detection system employing two light sources (e.g., lasers), a first light source emits a first wavelength of light which efficiently excites a first set of dyes comprising one or more dyes and which does not efficiently excite a second set of dyes. A second light source emits a second wavelength of light which efficiently excites a second set of dyes comprising one or more dyes and which optionally does not efficiently excite the first set of dyes. In certain embodiments, the first wavelength of light from the first light source and the second wavelength of light from the second light source are separated by at least about 75, 100, 125, 150, 175 or 200 nm. In further embodiments, the wavelength of maximum emission of the dye in the first set of dyes which has the longest emission maximum wavelength among the one or more dyes in the first set of dyes is shorter than the wavelength of maximum emission of the dye in the second set of dyes which has the shortest emission maximum wavelength among the one or more dyes in the second set of dyes.

Each of the plurality of light sources is selected to output one or more wavelengths of light, or one or more light emissions of a relatively narrow bandwidth, capable of efficiently exciting at least one of the plurality of spectrally resolvable fluorescent dyes used to label nucleic acid fragments in a set of dye-labeled fragments produced from a sample. An organic fluorescent dye typically has an excitation/absorption spectrum whose peak represents the excitation/absorption maximum. In some embodiments, a wavelength of light efficiently excites a dye if the wavelength of light excites at least about 10%, 15% or 20% of the maximum absorbance of the dye. In certain embodiments, a dye is efficiently excited by a wavelength of light within ±about 30, 25, 20, 15, 10 or 5 nm of the excitation maximum of the dye, where the wavelength of light excites at least about 10%, 15% or 20% of the maximum absorbance of the dye. In some embodiments, each of the light sources emits light that excites a different subset of the plurality of spectrally resolvable fluorescent dyes in each separation channel separating a set of dye-labeled nucleic acid fragments produced from a sample, where a subset of dyes comprises one or more dyes.

In some embodiments, each of the plurality of light sources emits one or more wavelengths of light in the ultraviolet region, the violet region, the blue region, the green region, the yellow region, the orange region, the red region, or the infra-red region of the light spectrum, or a combination thereof. In further embodiments, each of the light sources emits one or more wavelengths of light substantially similar to (e.g., within ±about 30, 25, 20, 15, 10 or 5 nm of) one or more of the approximate excitation maximum wavelengths of the dyes included in Table 1. In certain embodiments, each of the light sources (e.g., lasers) emits one or more wavelengths of light selected from the group consisting of about 350 nm, about 375 nm, about 405 nm, about 430 nm, about 445 nm, about 488 nm, about 514 nm, about 532 nm, about 546 nm, about 552 nm, about 568 nm, about 594 nm, about 610 nm, about 637 nm, about 640 nm, about 647 nm, about 650 nm, about 655 nm, about 660 nm, about 680 nm, about 685 nm, about 700 nm, about 730 nm, about 750 nm, about 785 nm, and about 800 nm. In an embodiment, the plurality of light sources (e.g., lasers) have output wavelengths of about 488 nm and about 650 nm.

Table 2 shows non-limiting examples of spectrally resolvable fluorescent dyes (including energy-transfer dye pairs) that can be excited by certain wavelengths of light from a light source.

TABLE 2

| Wavelength of | |
|---|---|
| Light (nm) | Spectrally Resolvable Fluorescent Dyes |
| 350 | Alexa Fluor 350, Marina Blue, methoxycoumarin |
| 375 | AMCA-X, Marina Blue, methoxycoumarin |
| 405 | Alexa Fluor 405, Pacific Blue, Pacific Orange |
| 445 | Alexa Fluor 430 |
| 488 | Cy 2, EvaGreen, 5- or 6-FAM, 5- or 6-JOE, 5- or |
| | 6-FAM/TMR, 5- or 6-FAM/5- or 6-ROX, |
| | 5- or 6-JOE/TOM |
| 514 | BODIPY FL, 5- or 6-JOE, MAX, Oregon Green 514 |
| 532 | Alexa Fluor 532, 5- or 6-TET, TMR |
| 552 | Alexa Fluor 610 or 647 R-phycoerythrin streptavidin, |
| | lissamine rhodamine B (5- or 6-isomer), |
| | 5- or 6-TAMRA, TYE 563 |
| 594 | Alexa Fluor 594, BODIPY 581/591, |
| | carboxynaphthofluorescein (5- or 6-isomer), 5- or 6-ROX |
| 637 | Alexa 633, Atto 647 |
| 660 | Alexa Fluor 660, TYE 665 |
| 685 | Alexa 700, WellRED D3 |
| 750 | Alexa Fluor 750, 5′ IRDye 800CW |
| 785 | 5′ IRDye 800, 5′ IRDye 800CW, WellRED D2 |

To reduce noise generated from illumination of other light source(s) during illumination of a given light source, in some embodiments the plurality of light sources are configured such that light emitted by each of the light sources is spatially separated from one another, or light emitted by each of the light sources is spatially separated from light emitted by any of the other one or more light sources at any given time, or light emitted by each of the light sources is spatially separated from light emitted by every other light source. In some embodiments, no two light sources illuminate the same point of any one of the one or more separation channels at a given time. In further embodiments, each of the light sources illuminates a spatially different point of the one or more separation channels at a given time. To improve detection sensitivity, in additional embodiments the interior of a given separation channel is illuminated by a single light source at a given time, which can be achieved by spacing apart the light emissions of the light sources from one another by an appropriate distance, where the intensity of the light sources may or may not be on/off modulated.

For an electrophoresis system comprising a substantially planar array of capillaries, where each of the capillaries contacts at least one other capillary, the light emissions of the plurality of light sources can be spaced apart to optimize detection sensitivity. If each of the capillaries has an outer diameter (OD)/inner diameter (ID) ratio of about two or greater, the interior of a given capillary can be illuminated by a single light source at a given time by spacing apart the light emissions of the light sources by a distance from about ID to about (OD-ID), where the intensity of the light sources may or may not be modulated. If each of the capillaries has an OD/ID ratio of less than about two, illumination of the interior of a given capillary by more than one light source at a given time can be minimized by spacing apart the light emissions of the light sources by a distance of about OD/2.

In some embodiments, exciting the plurality of spectrally resolvable fluorescent dyes in each of the one or more separation channels separating a set of dye-labeled nucleic acid fragments produced from a sample comprises scanning each of the plurality of light sources across the interior of each of the one or more separation channels in the on mode, or scanning light emitted by each of the light sources across the interior of each separation channel when each of the light sources is in the on mode. Scanning can comprise moving at least one optical element (e.g., objective lens) through which light emitted by the plurality of light sources passes such that light from each light source focuses at a different location in the interior of each separation channel as the at least one optical element moves across the interior of each separation channel. There can be a separate optical element for each of the light sources, or an optical element can direct or focus light emitted by a plurality of, or all, the light sources.

In certain embodiments, each of the light sources scans across the interior and the exterior of each of the one or more separation channels at a rate of about 1, 5, 10, 20, 30, 40, 50 Hz or greater, or in the range of about 1-100, 1-50, 1-20 or 1-10 Hz. In an embodiment, each of the light sources scans across the interior and the exterior of each separation channel at a rate of about 2.5 Hz. The interior of a separation channel includes the hollow portion or bore of a separation channel through which fragments travel during electrophoresis, and the exterior of a separation channel includes the wall (e.g., the thickness of the wall) of the separation channel. In certain embodiments, the exterior of a separation channel further includes the outer environment of the separation channel.

In some embodiments, each of the plurality of light sources scans across the interior of each of the one or more separation channels in a direction substantially perpendicular to the longitudinal direction of the one or more separation channels at the detection region, or the point of detection, of the one or more separation channels. In certain embodiments, each of the light sources scans with illumination across the interior of each separation channel in one direction (e.g., from A to B), returns to the starting scanning position without illumination during the return (e.g., from B to A), and repeats for the desired number of cycles of scanning. In further embodiments, each of the light sources scans with illumination across the interior of each separation channel in one direction (e.g., from A to B), scans with illumination across the interior of each separation channel in substantially the opposite direction (e.g., from B to A), and repeats for the desired number of cycles of scanning. In other embodiments, at least one light source of the plurality of light sources scans with illumination across the interior of each separation channel in one direction (e.g., from A to B) and returns to its starting scanning position without illumination during the return, at least one other light source scans with illumination across the interior of each separation channel in substantially the opposite direction (e.g., from B to A) and returns to its starting scanning position without illumination during the return, and the light sources repeat for the desired number of cycles of scanning. In additional embodiments, at least one light source of the plurality of light sources starts scanning with illumination across the interior of each separation channel in one direction (e.g., from A to B) and scans with illumination across the interior of each separation channel when it returns to its starting scanning position, at least one other light source starts scanning with illumination across the interior of each separation channel in substantially the opposite direction (e.g., from B to A) and scans with illumination across the interior of each separation channel when it returns to its starting scanning position, and the light sources repeat for the desired number of cycles of scanning.

To improve detection sensitivity and to extend the lifetime of light sources (e.g., lasers), in some embodiments the intensity of each of the plurality of light sources is on/off modulated during detection. Fluorescence of a dye labeling a nucleic acid fragment migrating through a separation channel is induced when a light source illuminates the interior of the separation channel with an appropriate wavelength of light. Therefore, the light source does not need to be on when it is not illuminating the interior of the separation channel. Accordingly, in some embodiments each of the plurality of light sources is in the on mode when the light source scans across the interior of each of the one or more separation channels, and each of the light sources is in the off mode when the light source scans across the exterior of each separation channel. In certain embodiments, each of the light sources has an intensity modulation frequency of about 1, 5, 10, 20, 50, 100 Hz or greater. In an embodiment, each of the light sources has an intensity modulation frequency of about 20 Hz.

If the light sources are scanned across a plurality of separation channels and are on/off modulated, the frequency of intensity modulation of the light sources can depend on various factors, including the rate of scanning of the light sources and the number of separation channels across which the light sources are scanned. Table 3 shows examples of the approximate frequency of intensity modulation of light sources (e.g., lasers) as a function of the rate of scanning of the light sources and the number of capillaries in an electrophoresis system comprising a substantially planar array of capillaries, where each of the capillaries has an OD of about 150 μm and an ID of about 75 μm and contacts at least one other capillary. The intensity of the light sources can be modulated by digital pulsing or analog control of the output of the light sources. The emission spectra of dyes excited by the light sources are collected by a detector that collects data fast enough to prevent emission collection crosstalk. The detector can comprise, e.g., a CCD (charge-coupled device) camera, a CMOS (complementary metal oxide semiconductor) camera, a photomultiplier tube or a photodiode sensor.

TABLE 3

| | Number of Capillaries | | | | |
|---|---|---|---|---|---|
| Scan Rate (Hz) | 8 | 16 | 32 | 64 | 96 |
| 2.5 | 20 | 40 | 80 | 160 | 240 |
| 5 | 40 | 80 | 160 | 320 | 480 |
| 7.5 | 60 | 120 | 240 | 480 | 720 |
| 10 | 80 | 160 | 320 | 640 | 960 |

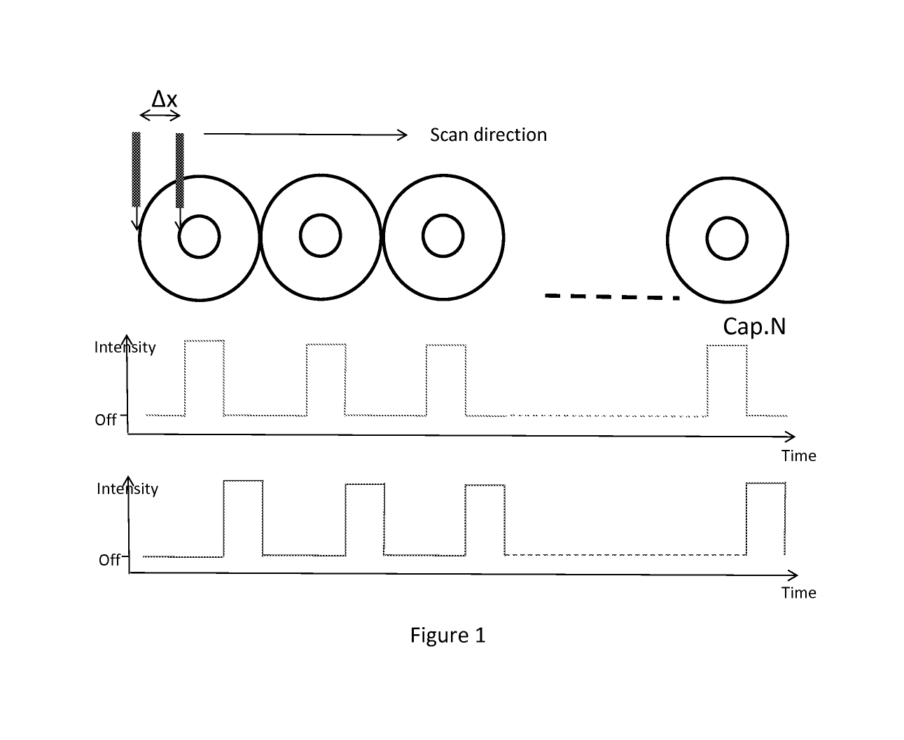

To minimize noise from illumination of other light source(s), the interior of a given separation channel can be illuminated by a single light source at a given time by spatially separating the light emissions of the light sources from one another by an appropriate distance and/or by modulating the intensity of the light sources at an appropriate frequency. FIG. 1 shows an embodiment of illumination of the interior of a given separation channel by a single light source (e.g., a laser) at a given time by spatially separating the light emissions of a two-light source system and modulating the intensity of the light sources (e.g., lasers). In FIG. 1, the electrophoresis system comprises a substantially planar array of a plurality of capillaries, where each of the capillaries contacts at least one other capillary. The detection system comprises two light sources (e.g., lasers) whose light emissions are spatially separated from one another by distance x and which scan across the interior of each of the capillaries in a direction substantially perpendicular to the longitudinal direction of the capillaries at the detection region and in substantially the same direction. Each of the light sources is in the on mode when the light source scans across the interior of each of the capillaries, and is in the off mode when the light source scans across the exterior of each of the capillaries. By spatially separating the light emissions of the light sources from one another by an appropriate distance and/or by modulating the intensity of the light sources at an appropriate frequency, the interior of a given capillary can be illuminated by a single light source at a given time. For example, if the thickness of the wall of the capillaries is substantially equal to the inner diameter (the diameter of the interior) of the capillaries, separation of the light emissions of the two light sources by a distance substantially equal to the wall thickness and/or temporal modulation of the intensity of the light sources according to the profiles in FIG. 1 provide out-of-phase illumination of the interior of the capillaries.

As an alternative to scanning each of the plurality of light sources across each of the one or more separation channels, the interior of each of the one or more separation channels can be illuminated by shining light from each of the plurality of light sources (e.g., lasers) across each of the one or more separation channels from either side or both sides of the array of the one or more separation channels. In some embodiments, each of a plurality of non-scanning light sources shines light across each of the one or more separation channels from one side of the array of the one or more separation channels. In further embodiments, at least one light source of a plurality of non-scanning light sources shines light across each of the one or more separation channels from one side of the array of the one or more separation channels, and at least one other non-scanning light source shines light across each separation channel from the other side of the array of the separation channel(s). In certain embodiments, the light from each of the non-scanning light sources follows substantially the same path, or a substantially similar path, across each of the one or more separation channels. In additional embodiments, the non-scanning light sources are intensity-modulated to be on at different times so that they illuminate the interior of each of the one or more separation channels at different times.

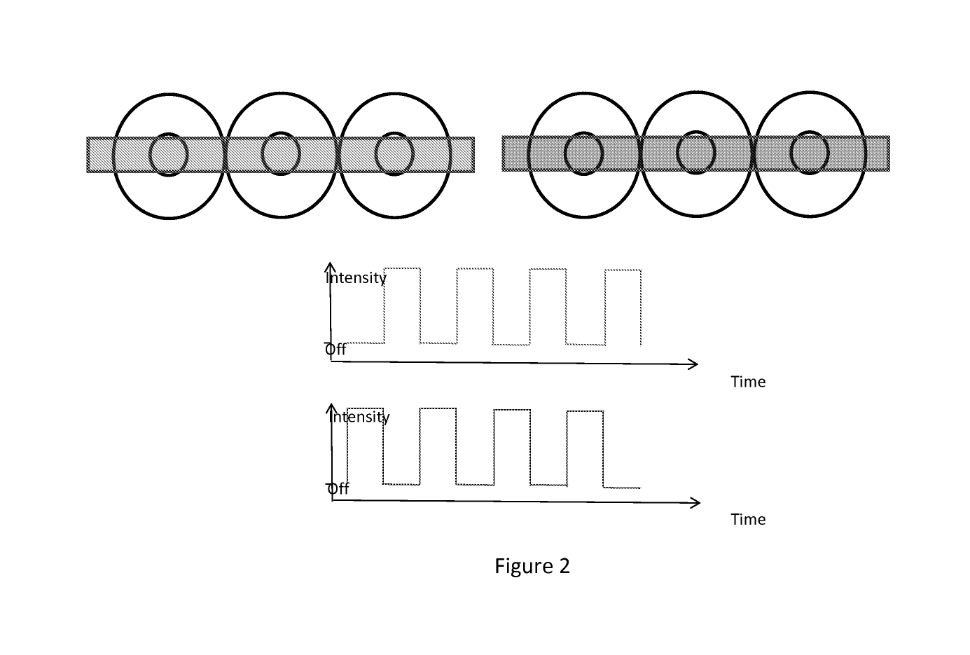

Alternative to the non-scanning, non-staring configurations described above, the plurality of light sources (e.g., lasers) can have a non-scanning, staring configuration. In some embodiments, each of a plurality of non-scanning light sources shines light at a mirror or lens at one side of an array of one or more separation channels, and the light from each of the light sources reflects off the mirror or lens across each of the one or more separation channels. In further embodiments, at least one light source of a plurality of non-scanning light sources shines light at a first mirror or lens at one side of an array of one or more separation channels and the light from the at least one light source reflects off the first mirror or lens across each of the one or more separation channels, and at least one other non-scanning light source shines light at a second mirror or lens at the other side of the array of separation channel(s) and the light from the at least one other non-scanning light source reflects off the second mirror or lens across each separation channel. In certain embodiments, the light from each of the non-scanning light sources follows substantially the same path, or a substantially similar path, across each of the one or more separation channels. In additional embodiments, the non-scanning light sources are intensity-modulated to be on at different times so that they illuminate the interior of each of the one or more separation channels at different times. FIG. 2 shows profiles of light source intensity modulation for out-of-phase illumination of the interior of capillaries by two light sources (e.g., lasers) having a non-scanning, staring configuration. In FIG. 2, each of the two non-scanning light sources shines light at a mirror or lens at one side of a substantially planar array of a plurality of capillaries, where each of the capillaries contacts at least one other capillary, the light from each of the light sources reflects off the mirror or lens across each of the capillaries, and the two light sources are intensity-modulated to be on at different times.

For an electrophoresis system comprising a plurality of separation channels and used with light sources (e.g., lasers) having a non-scanning, non-staring configuration or a non-scanning, staring configuration, the detector is capable of detecting the emission spectra of excited dyes from the plurality of separation channels simultaneously. The detector can comprise, e.g., a CCD camera, a CMOS camera, a photomultiplier tube or a photodiode sensor.

In other embodiments, a different detector or sensor is locked onto the frequency of intensity modulation of each different light source, where each light source can have a scanning or non-scanning configuration. By being locked onto the frequency of intensity modulation of a particular light source, a particular detector or sensor collects mostly, or only, fluorescence emission signals induced by that light source. The detector or sensor can operate fast enough to collect signals induced at a certain frequency. The detector or sensor can comprise, e.g., a photomultiplier tube.

Each of the one or more separation channels can have any configurations and any dimensions suitable for separation of the one or more sets of dye-labeled nucleic acid fragments. In certain embodiments, each of the one or more separation channels has a substantially circular, substantially oval, substantially squarish, substantially rectangular, substantially triangular, substantially trapezoidal, or irregular cross-section. The one or more separation channels can be discrete elements of the electrophoresis system, can contact one another, or can be formed in a structure (e.g., a monolithic structure) of the electrophoresis system. For example, the one or more separation channels can be comprised in a common or single substrate, e.g., a piece comprising one or more separation channels formed on a surface and bonded to a layer (e.g., a sealing layer) to form an enclosure for the one or more separation channels, or a piece in which one or more separation channels have been created.

In some embodiments, each of the one or more separation channels is a capillary. In certain embodiments, the electrophoresis system comprises an array (e.g., a substantially planar array) of a plurality of capillaries, where each of the capillaries may or may not contact at least one other capillary. In some embodiments, each of the one or more capillaries has an inner diameter (ID) of about 50-150, 100-150, 50-100, 75-100 or 50-75 microns, and an outer diameter (OD) of about 150-300, 150-250, 200-300, 250-300, 200-250 or 150-200 microns. In further embodiments, each of the one or more capillaries has an OD/ID ratio of about 2, 2.5, 3, 3.5, 4 or greater.

Each of the one or more separation channels can have any length suitable for separation. Because use of a greater number of spectrally resolvable dyes to label fragments permits more overlapping of fragments with differentiation, the fragments can be adequately separated and distinguished using a smaller range of fragment sizes/lengths. Shorter fragments separate more rapidly and with better resolution in electrophoresis. Accordingly, adequate separation of shorter fragments can be achieved with a shorter separation channel. In certain embodiments, each of the one or more separation channels has a length to detection region, or a length to point of detection, not greater than about 100, 80, 60, 50, 40 or 20 cm. More overlapping of fragments with differentiation also enables separation of nucleic acid fragments labeled with a plurality of spectrally resolvable fluorescent dyes in a single run.

Each of the one or more separation channels can comprise a separation polymer or gel. Examples of separation polymers and gels that can be used to separate nucleic acid fragments by electrophoresis include agarose and polyacrylamide (e.g., the LPA line (including LPA-1) of separation gels (Beckman Coulter) and the POP™ line (including POP-4™, POP-6™ and POP-7™) of separation polymers (Life Technologies)). To separate single-stranded nucleic acid fragments, denaturing gel electrophoresis can be performed using a separation polymer or gel that comprises a chemical denaturant (e.g., urea or formamide) or at a temperature (e.g., about 85 or 90° C. or higher) that denatures double-stranded nucleic acid fragments.

Each set of the one or more sets of dye-labeled nucleic acid fragments produced from one or more samples can comprise DNA, RNA, a natural or synthetic variant of DNA or RNA, or a combination thereof. In some embodiments, each set of dye-labeled nucleic acid fragments produced from a sample comprises dye-labeled DNA fragments. In further embodiments, each set of dye-labeled nucleic acid fragments produced from a sample comprises dye-labeled fragments that comprise a short tandem repeat (STR) sequence. In additional embodiments, the dye-labeled nucleic acid fragments of each set of dye-labeled nucleic acid fragments produced from a sample are dye-labeled amplicons produced by PCR amplification (including standard PCR and variants thereof, such as allele-specific PCR, assembly PCR, asymmetric PCR, hot-start PCR, intersequence-specific PCR, inverse PCR, isothermal PCR (e.g., helicase-dependent amplification and PAN-AC), ligation-mediated PCR, mini-primer PCR, multiplex PCR, nested PCR, picotiter PCR, quantitative PCR, real-time PCR, restriction fragment length polymorphism PCR, reverse transcription PCR, single-cell PCR, solid-phase PCR (e.g., bridge PCR), thermal asymmetric interlaced PCR, touchdown (step-down) PCR, and universal fast walking PCR). In some embodiments, each set of dye-labeled nucleic acid fragments produced from a sample comprises dye-labeled amplicons of a plurality of (e.g., at least 5, 6 or 10) different genetic loci. In certain embodiments, each set of dye-labeled nucleic acid fragments produced from a sample comprises dye-labeled amplicons of a plurality of (e.g., at least 5, 6 or 10) different STR loci.

The method described herein is useful for performing human identification by STR analysis. For example, each set of the one or more sets of dye-labeled nucleic acid fragments produced from one or more samples can comprise dye-labeled amplicons of a plurality of (e.g., at least 5, 6 or 10) STR loci utilized in a forensic database (e.g., CODIS). In some embodiments, each set of dye-labeled nucleic acid fragments produced from a sample comprises dye-labeled fragments that independently comprise a sequence of an STR locus selected from the group consisting of the 13 present CODIS STR loci, CSF1PO, D3S1358, D5S818, D7S820, D8S1179, D13S317, D16S539, D18S51, D21S11, FGA, TH01, TPDX and vWA, plus two other STR loci useful for human identification, Penta D and Penta E, where each set comprises dye-labeled fragments comprising sequences of a plurality of (e.g., at least 5, 6 or 10) different STR loci. In certain embodiments, each set of dye-labeled nucleic acid fragments produced from a sample comprises dye-labeled fragments that independently comprise an STR sequence of each one of CSF1PO, D3S1358, D5S818, D7S820, D8S1179, D13S317, D16S539, D18S51, D21S11, FGA, TH01, TPDX, and vWA. In further embodiments, each set of dye-labeled nucleic acid fragments produced from a sample comprises dye-labeled fragments that independently comprise an STR sequence of each one of CSF1PO, D3S1358, D5S818, D7S820, D8S1179, D135317, D165539, D18S51, D21S11, FGA, TH01, TPDX, vWA, Penta D, and Penta E. In additional embodiments, each set of dye-labeled fragments produced from a sample and comprising sequences of a plurality of (e.g., at least 5, 6 or 10) STR loci useful for human identification further comprises a dye-labeled fragment that comprises a sequence of a locus useful for sex determination, such as amelogenin (AMEL).

Polymorphic genetic loci of a species can have alleles that span a length range, e.g., a range of number of nucleotides. For example, a first locus can have a set of alleles in which the shortest allele has 50 nucleotides per strand and the longest allele has 100 nucleotides per strand, and there can be one or more alleles of the locus having lengths between 50 and 100 nucleotides. Two or more different polymorphic genetic loci can have alleles that span length ranges that at least partially overlap. For example, a first locus can have alleles that span a length range of 50 nucleotides to 100 nucleotides, and a second locus can have alleles that span a length range of 75 nucleotides to 150 nucleotides. Alleles of different loci having closely matched or exactly overlapping lengths may be difficult to be distinguished from one another by electrophoresis. Amplification products (or amplicons) of alleles of different loci which have closely matched or exactly overlapping lengths can be distinguished by, e.g., labeling alleles of each different locus with a different spectrally resolvable dye and separating them electrophoretically. Amplification products of alleles of different genetic loci which have closely matched or overlapping (e.g., exactly overlapping) lengths and are difficult to distinguish by electrophoresis are amplification products of alleles of “overlapping loci”.

Use of two or more light sources allows for excitation of a greater number of spectrally resolvable dyes used to label nucleic acid fragments. Accordingly, the present method provides the ability to differentiate in a single electrophoretic run dye-labeled fragments of a greater number of different genetic loci whose dye-labeled amplification products fall within length ranges that at least partially overlap one another. Such differentiation can be achieved, e.g., by labeling amplification products of each of the loci with a different spectrally resolvable dye. Furthermore, because use of a greater number of spectrally resolvable dyes permits nucleic acid fragments of a greater number of different loci within a given length range to be distinguished, the total number of different loci in the full size spread can also be increased.

In some embodiments, the present method distinguishes amplification products of at least 5, 6, 7, 8, 9, 10 or 11 different overlapping loci, e.g., by labeling amplification products of each different locus with a different spectrally resolvable dye. In certain embodiments, each set of dye-labeled nucleic acid fragments produced from a sample comprises dye-labeled amplicons of at least 5, 6, 9, 10 or 11 different polymorphic genetic loci of a species (e.g., humans), where each of the at least 5, 6, 9, 10 or 11 different polymorphic genetic loci of different members of the species can be amplified to produce dye-labeled amplicons within a certain size/length range, dye-labeled amplicons of each of the at least 5, 6, 9, 10 or 11 different polymorphic genetic loci are labeled with a different spectrally resolvable dye, and the size/length ranges of dye-labeled amplicons of the at least 5, 6, 9, 10 or 11 different polymorphic genetic loci at least partially overlap one another. Use of a plurality of (e.g., 2, 3 or more) light sources to interrogate a plurality of spectrally resolvable dyes enables differentiation of dye-labeled amplicons of at least 5, 6, 9, 10 or 11 different genetic loci which can have the same size/length and can migrate with the same electrophoretic mobility.

Amplification products of two or more different genetic loci which are labeled with a total of only one dye can also be distinguished if amplification products of each locus are configured to span a length range that does not overlap the length range of amplification products of any other locus. For example, amplification of a first locus can produce amplicons that span 70-100 nucleotides, amplification of a second locus can produce amplicons that span 101-130 nucleotides, and amplification of a third locus can produce amplicons that span 131-160 nucleotides. Such configuration of amplification products of different genetic loci are referred to herein as size spreading of loci.

Because use of a greater number of spectrally resolvable dyes to label fragments permits more overlapping of fragments with differentiation, adequate separation of the fragments can be achieved with a smaller range of fragment sizes/lengths. In certain embodiments, each of the dye-labeled nucleic acid fragments of each set of dye-labeled nucleic acid fragments produced from a sample comprises no more than about 350, 325, 300, 275, 250, 225, 200, 175 or 150 bases (for single-stranded fragments) or base pairs (for double-stranded fragments). In further embodiments, each dye-labeled fragment comprising a sequence of an STR locus useful for human identification (e.g., one of the CODIS STR loci, Penta D or Penta E), or a sequence of amelogenin, comprises from about 12 bases (for single-stranded fragments)/12 base pairs (for double-stranded fragments) to about 186 bases (for single-stranded fragments)/186 base pairs (for double-stranded fragments).

In some embodiments, the present method distinguishes amplification products of at least 10, 12, 14, 16, 18 or 20 different genetic loci (e.g., all the loci used in a forensic database, such as CODIS), where the amplification products of each of the loci span a length range of no more than about 350, 325, 300, 275, 250 or 230 bases (for single-stranded fragments) or base pairs (for double-stranded fragments), optionally using no more than 7 or 8 spectrally resolvable dyes.

The one or more samples can comprise genetic sequences of any organisms. In some embodiments, the dye-labeled nucleic acid fragments of each set of dye-labeled nucleic acid fragments produced from a sample comprise genetic sequences of one or more organisms selected from the group consisting of animals, mammals, humans, plants, microbes, pathogens, bacteria, fungi, and viruses. In certain embodiments, the dye-labeled nucleic acid fragments of at least one set, or each set, of the one or more sets of dye-labeled nucleic acid fragments produced from one or more samples comprise genetic sequences of a plurality of different pathogens (e.g., pathogenic microbes). In additional embodiments, the method comprises separating a plurality of sets of dye-labeled nucleic acid fragments produced from a plurality of human samples, wherein each set of dye-labeled nucleic acid fragments is produced from a different human sample. In certain embodiments, the plurality of sets of dye-labeled nucleic acid fragments comprise genetic sequences of a plurality of humans, wherein each set of dye-labeled nucleic acid fragments comprises genetic sequences of a different human.

In addition to separating one or more sets of dye-labeled nucleic acid fragments produced from one or more samples, the method can comprise use of one or more controls. In some embodiments, a size standard (also called size marker, internal lane standard or molecular weight ladder) is used. In further embodiments, an allelic ladder (a plurality of alleles of each of one or more loci) is used. In certain embodiments, the allelic ladder comprises a plurality of alleles of each of the CODIS STR loci, and optionally of Penta D, Penta E and/or amelogenin. In yet further embodiments, a positive control is used. In certain embodiments, the positive control comprises purified genomic DNA of a known subject (e.g., a known human), and the DNA of the positive control undergoes PCR amplification at the same loci (e.g., all the CODIS STR loci, plus optionally Penta D, Penta E and/or amelogenin) as the DNA from a sample. In additional embodiments, a negative control is used. In certain embodiments, the negative control contains no DNA to be amplified, but rather contains the same dye-labeled primer oligonucleotides used to amplify by PCR selected loci (e.g., all the CODIS STR loci, plus optionally Penta D, Penta E and/or amelogenin) of the DNA of a sample.

Each of the nucleic acid fragments of the size standard, the allelic ladder and the negative control, and each of the fragments generated by PCR amplification from the DNA of the positive control, can be labeled with a single dye or multiple dyes (e.g., an energy-transfer dye pair). Each set of the fragments of the size standard, the allelic ladder and the negative control, and the set of the fragments generated from the positive control, can each be labeled with a single dye or a plurality of spectrally resolvable fluorescent dyes, depending on, e.g., whether use of a single dye would result in adequate differentiation of the fragments. In certain embodiments, each set of the fragments of the allelic ladder and the negative control, and the set of the fragments generated from the positive control, are each labeled with a plurality of spectrally resolvable fluorescent dyes, and the set of the fragments of the size standard is labeled with a single dye or a plurality of spectrally resolvable fluorescent dyes.

In some embodiments, a size standard is run in each separation channel separating dye-labeled nucleic acid fragments produced from a sample. If an allelic ladder, a positive control and/or a negative control are used, in some embodiments the allelic ladder, the positive control and/or the negative control are each run in a different separation channel that does not separate dye-labeled fragments produced from a sample. In further embodiments, a size standard is run in each of the separation channel(s) separating dye-labeled fragments of the allelic ladder, those of the negative control, and/or those generated from the positive control.

Analysis of the emission spectra of excited dyes can be performed to identify the dye-labeled nucleic acid fragments of each set of dye-labeled fragments produced from a sample (and those of or generated from any controls utilized) and subjected to separation and detection. In some embodiments, a computer-readable profile of each set of dye-labeled nucleic acid fragments produced from a sample and subjected to separation and detection is created. In further embodiments, a computer and computer-executable code are used to determine one or more, or all, genetic loci from which one or more, or all, dye-labeled nucleic acid fragments in each set of dye-labeled nucleic acid fragments produced from a sample are derived. In additional embodiments, the computer and computer-executable code are used to determine one or more, or all, allelic forms of the one or more, or all, determined genetic loci.

The method can also comprise any steps relating to the preparation and processing of the one or more sets of dye-labeled nucleic acid fragments produced from one or more samples prior to their separation by electrophoresis. In some embodiments, the method further comprises, prior to separating, performing PCR amplification on nucleic acid obtained from each of the one or more samples to produce the one or more sets of dye-labeled nucleic acid fragments produced from one or more samples. The plurality of spectrally resolvable fluorescent dyes can be introduced by utilizing primers labeled with the dyes to amplify target loci (e.g., all the CODIS STR loci, plus optionally Penta D, Penta E and/or amelogenin) of the nucleic acid (e.g., DNA) obtained from each of the one or more samples. In further embodiments, the method further comprises, prior to performing PCR amplification, extracting nucleic acid (e.g., DNA) from each of the one or more samples (e.g., from cells in each sample) and isolating the extracted nucleic acid. In certain embodiments, isolation of the extracted nucleic acid comprises covalently or non-covalently binding the extracted nucleic acid to capture particles (e.g., magnetic particles). For example, the extracted nucleic acid can bind to capture particles by precipitating onto the particles. In additional embodiments, the method further comprises purifying the isolated nucleic acid prior to amplifying target regions of the nucleic acid. The isolated nucleic acid can be purified by, e.g., washing the nucleic acid bound to capture particles with suitable wash solution(s) or buffer(s) and removing the supernatant(s) while the particles are immobilized or have precipitated.

Further embodiments of the disclosure relate to a device configured to perform the method of separating and detecting dye-labeled nucleic acid fragments using a plurality of light sources as described herein. In some embodiments, the device comprises:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a plurality of light sources configured to excite the plurality of spectrally resolvable fluorescent dyes in each of the one or more separation channels separating a set of dye-labeled nucleic acid fragments produced from a sample,
wherein each of the plurality of dyes is excited, and
wherein in some embodiments each of the plurality of light sources emits light which is spatially separated from light emitted by any of the other light source(s) at any given time; and

a detector configured to detect light emitted by each of the plurality of excited dyes in each of the one or more separation channels separating a set of dye-labeled nucleic acid fragments produced from a sample.

To minimize noise from illumination of other light source(s) during illumination of a given light source, in some embodiments the interior of a given separation channel is illuminated by a single light source at a given time, which can be achieved by spatially separating the light emissions of the light sources by an appropriate distance and/or by modulating their intensity at an appropriate frequency as described herein. In certain embodiments, no two light sources illuminate the same point of any one of the one or more separation channels at a given time, which can be achieved by spatially separating the light emissions of the light sources and/or by on/off modulating their intensity. In further embodiments, each of the light sources illuminates a spatially different point of the one or more separation channels at a given time, which can be achieved by spatially separating the light emissions of the light sources from one another. Alternative to or in addition to spatially separating the light emissions of the light sources from one another, detection sensitivity can be improved by modulating the intensity of each of the light sources. In certain embodiments, each of the plurality of light sources is in the on mode when the light source scans across the interior of each of the one or more separation channels, and each of the light sources is in the off mode when the light source scans across the exterior of each separation channel. In other embodiments, the light sources have a non-scanning, non-staring configuration or a non-scanning, staring configuration from one side or both sides of an array of one or more separation channels, and the light sources are intensity-modulated to be on at different times, as described herein. In further embodiments, a separate detector or sensor is locked onto the frequency of intensity modulation of each different light source, where each light source can have a scanning or non-scanning configuration.

The device comprises a detection system or optical assembly comprising the plurality of light sources and the detector. Each of the light sources can be any light source capable of outputting one or more light emissions of a relatively narrow bandwidth, e.g., no more than ±about 30, 25, 20, 15, 10, 5, 3 or 1 nm of the selected output wavelength or the maximum output wavelength of a given light emission. Each of the light sources can be, e.g., a laser, an LED, a lamp with a relatively narrow filter, or a flash lamp with a relatively narrow filter. In an embodiment, each of the light sources is a laser. The detector can be any detector or sensor capable of detecting light emitted by each of the plurality of excited dyes in each of the one or more separation channels separating a set of dye-labeled nucleic acid fragments produced from a sample. The detector can comprise, e.g., a CCD camera, a CMOS camera, a photomultiplier tube or a photodiode sensor.

The detection system or optical assembly can further comprise at least one optical element (e.g., objective lens) that directs or focuses light emitted by each of the light sources to the interior of each of the one or more separation channels. There can be a separate optical element for each of the light sources, or an optical element can direct or focus light emitted by a plurality of, or all, the light sources. Furthermore, the detection system or optical assembly can comprise elements that collect fluorescence emissions from each separation channel separating a set of dye-labeled nucleic acid fragments produced from a sample and direct the fluorescence emissions to the detector. If the light sources have a scanning configuration, the detection system or optical assembly can comprise a scanning assembly that comprises a motor configured to move the light sources and/or at least one optical element (e.g., objective lens) so that light emitted by each of the light sources scans across the interior of each of the one or more separation channels.

In addition to one or more separation channels, the electrophoresis system of the device can comprise other elements for performing electrophoresis. For example, the electrophoresis system can comprise a power supply configured to supply voltage to each of the one or more separation channels, e.g., by means of electrodes. The electrophoresis system can also comprise an injector configured to inject dye-labeled nucleic acid fragments into each separation channel separating a set of dye-labeled fragments produced from a sample. The electrophoresis system can further comprise a temperature-control element configured to control the temperature of each of the one or more separation channels—e.g., temperature-controlled air, a temperature-controlled surface, an oven, or a metal (e.g., copper) wire in contact with or in close proximity to each separation channel.

In additional embodiments, the device further comprises an analysis system configured to create a computer-readable profile of each set of dye-labeled nucleic acid fragments produced from a sample and subjected to separation and detection. The analysis system can receive data (e.g., signals) about the separation and detection of the dye-labeled fragments from the detection system and can comprise software or computer-executable code that processes and transforms the data into, e.g., electrophoretic traces. The software or code can analyze the data, e.g., to identify and/or to quantify or size a dye-labeled fragment (e.g., an allele of an STR locus). For example, the analysis system can comprise a computer and computer-executable code which determine one or more, or all, genetic loci from which one or more, or all, dye-labeled nucleic acid fragments in each set of dye-labeled fragments produced from a sample are derived, and which determine one or more, or all, allelic forms of the one or more, or all, determined genetic loci.

The device can also comprise any components for preparing and processing the one or more sets of dye-labeled nucleic acid fragments produced from one or more samples prior to their separation by electrophoresis. In some embodiments, the device further comprises a PCR amplification system configured to perform PCR amplification on nucleic acid obtained from each of the one or more samples to produce the one or more sets of dye-labeled nucleic acid fragments produced from one or more samples. In additional embodiments, the device further comprises a nucleic acid extraction and isolation system configured to extract nucleic acid from each of the one or more samples and to isolate the extracted nucleic acid.

In some embodiments, the device is portable or fits in a portable container. In certain embodiments, the device fits in a portable container (e.g., a case or bag) that can be carried by hand, by the shoulder or on the back by one or more people. In further embodiments, the device is transportable to the site where the one or more samples are collected.

The device for separating and detecting dye-labeled nucleic acid fragments using a plurality of light sources can comprise components of devices, systems and instruments described in, e.g., U.S. Provisional Patent Application No. 61/691,242, which is incorporated herein by reference in its entirety.

### Method and Device Employing One Light Source

Although a greater number of spectrally resolvable dyes can potentially be interrogated if multiple light sources are employed, a plurality of spectrally resolvable dyes can still be interrogated if a single light source is employed. Accordingly, some embodiments of the disclosure relate to a method of separating and detecting dye-labeled nucleic acid fragments using a single light source, which comprises:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

exciting each of the plurality of spectrally resolvable fluorescent dyes in each of the one or more separation channels separating a set of dye-labeled nucleic acid fragments produced from a sample with light emitted by a single light source,
wherein in some embodiments the single light source is scanned across the interior of each of the one or more separation channels in the on mode and is scanned across the exterior of each of the one or more separation channels in the off mode; and

detecting with a detector light emitted by each of the plurality of excited dyes in each of the one or more separation channels separating a set of dye-labeled nucleic acid fragments produced from a sample.

Every embodiment relating to the method of separating and detecting dye-labeled nucleic acid fragments using a plurality of light sources which is applicable to use of a single light source also applies to the method of separating and detecting dye-labeled nucleic acid fragments using a single light source.

The light source can have one or more output wavelengths or light emissions of a relatively narrow bandwidth, where one, or each, of the one or more output wavelengths or light emissions of a relatively narrow bandwidth can be selected to excite one or more (e.g., 2, 3, 4, 5 or more) spectrally resolvable dyes such that the light source excites a plurality of spectrally resolvable dyes. In certain embodiments, the light source has a single output wavelength or a single light emission of a relatively narrow bandwidth, and the single output wavelength or the single light emission of a relatively narrow bandwidth excites a plurality of (e.g., 2, 3, 4, 5 or more) spectrally resolvable dyes. In an embodiment, the light source (e.g., a laser) has an output wavelength of about 488 nm. In other embodiments, the light source has two output wavelengths or two light emissions of a relatively narrow bandwidth. In further embodiments, the light source has two output wavelengths or two light emissions of a relatively narrow bandwidth, and each of the two output wavelengths or light emissions of a relatively narrow bandwidth excites one or more (e.g., 2, 3, 4, 5 or more) spectrally resolvable dyes. In an embodiment, the light source (e.g., a laser) has two output wavelengths of about 488 nm and 514 nm.

In some embodiments, the light source scans across the interior and the exterior of each of the one or more separation channels. In some embodiments, the light source scans across the interior of each of the one or more separation channels in the on mode and scans across the exterior of each separation channel in the off mode. In certain embodiments, the light source is illuminated with on/off modulation while scanning across each of the one or more separation channels in one direction, is brought back to the scanning starting point without being illuminated, is illuminated with on/off modulation while scanning across each separation channel in the same direction, and so on depending on the desired number of cycles of scanning. In other embodiments, the light source is illuminated with on/off modulation while scanning across each of the one or more separation channels in one direction, is illuminated with on/off modulation while scanning across each separation channel in substantially the opposite direction, and so on depending on the desired number of cycles of scanning.

If the light source has multiple (e.g., two) output wavelengths or light emissions of a relatively narrow bandwidth that each excite one or more spectrally resolvable dyes and the light source scans across the interior and the exterior of each of the one or more separation channels, the light source can be configured to illuminate the interior of a given separation channel with a single wavelength or a single light emission of a relatively narrow bandwidth at a given time. In certain embodiments, the light source illuminates the interior of each of the one or more separation channels with a first wavelength or a first light emission of a relatively narrow bandwidth with or without on/off modulation of the intensity of the first wavelength or the first light emission of a relatively narrow bandwidth (e.g., by having on only the intensity of the first wavelength or the first light emission of a relatively narrow bandwidth or by using a filter that filters out all the other output wavelength(s) or light emission(s) and transmits only the first wavelength or the first light emission of a relatively narrow bandwidth) while scanning across each separation channel in one direction, is brought back to the scanning starting point without illuminating, illuminates the interior of each of the one or more separation channels with a second wavelength or a second light emission of a relatively narrow bandwidth with or without on/off modulation of the intensity of the second wavelength or the second light emission of a relatively narrow bandwidth (e.g., by having on only the intensity of the second wavelength or the second light emission of a relatively narrow bandwidth or by using a filter that filters out all the other output wavelength(s) or light emission(s) and transmits only the second wavelength or the second light emission of a relatively narrow bandwidth) while scanning across each separation channel in the same direction, and so on depending on the number of excitation wavelengths or excitation light emissions of the light source and the desired number of cycles of scanning. In other embodiments, the light source illuminates the interior of each of the one or more separation channels with a first wavelength or a first light emission of a relatively narrow bandwidth with or without on/off modulation of the intensity of the first wavelength or the first light emission of a relatively narrow bandwidth (e.g., by having on only the intensity of the first wavelength or the first light emission of a relatively narrow bandwidth or by using a filter that filters out all the other output wavelength(s) or light emission(s) and transmits only the first wavelength or the first light emission of a relatively narrow bandwidth) while scanning across each separation channel in one direction, illuminates the interior of each of the one or more separation channels with a second wavelength or a second light emission of a relatively narrow bandwidth with or without on/off modulation of the intensity of the second wavelength or the second light emission of a relatively narrow bandwidth (e.g., by having on only the intensity of the second wavelength or the second light emission of a relatively narrow bandwidth or by using a filter that filters out all the other output wavelength(s) or light emission(s) and transmits only the second wavelength or the second light emission of a relatively narrow bandwidth) while scanning across each separation channel in substantially the opposite direction, and so on depending on the number of excitation wavelengths or excitation light emissions of the light source and the desired number of cycles of scanning.

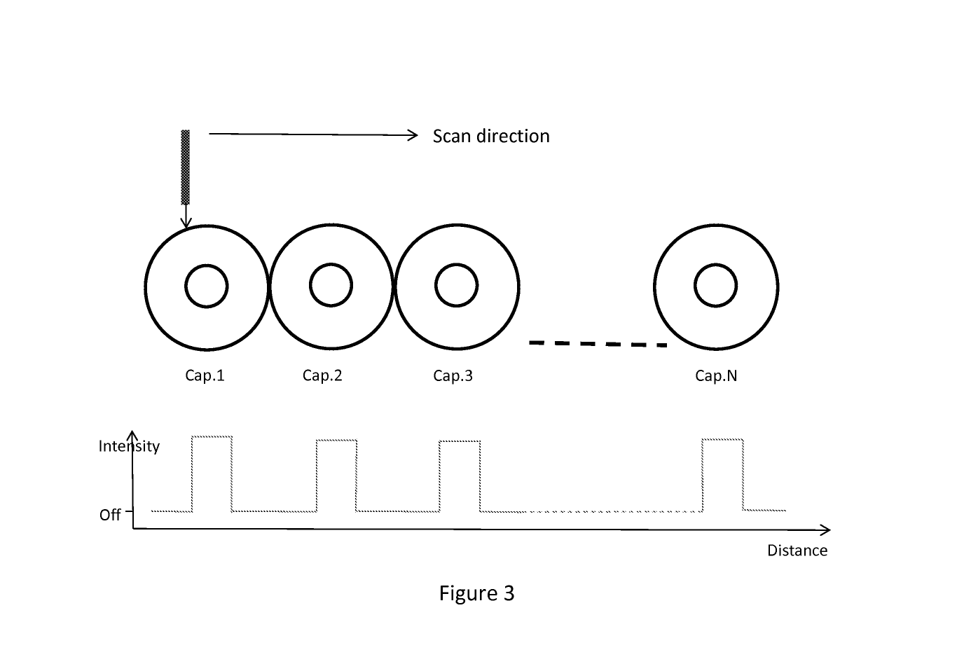

FIG. 3 illustrates an embodiment of illumination of only the interior of a plurality of capillaries by a single scanning light source (e.g., a laser) whose intensity is modulated. In FIG. 3, the electrophoresis system comprises a substantially planar array of a plurality of capillaries, where each of the capillaries contacts at least one other capillary, and the single light source scans across each of the capillaries in a direction substantially perpendicular to the longitudinal direction of each of the capillaries at the detection region, or the point of detection. The light source can have a single output wavelength or a single light emission of a relatively narrow bandwidth that excites a plurality of spectrally resolvable dyes, or can have multiple (e.g., two) output wavelengths or light emissions of a relatively narrow bandwidth that each excite one or more spectrally resolvable dyes. If the light source has multiple excitation wavelengths or multiple excitation light emissions of a relatively narrow bandwidth, illumination of the interior of a given capillary with a single wavelength or a single light emission of a relatively narrow bandwidth at a given time can be achieved by configuring the light source as described herein.

If the light source has multiple (e.g., two) output wavelengths or light emissions of a relatively narrow bandwidth that each excite one or more spectrally resolvable dyes, as an alternative to scanning across each of the one or more separation channels, the light source (e.g., a laser) can illuminate the interior of each separation channel by shining light across each separation channel from one side of the array of the one or more separation channels. In some embodiments, the light source (e.g., a laser) has a non-scanning, non-staring configuration. In certain embodiments, the light source shines light of a first wavelength or a first light emission of a relatively narrow bandwidth (e.g., by having on only the intensity of the first wavelength or the first light emission of a relatively narrow bandwidth or by using a filter that filters out all the other output wavelength(s) or light emission(s) and transmits only the first wavelength or the first light emission of a relatively narrow bandwidth) across each of the one or more separation channels from one side of the array of the one or more separation channels for a period of time (e.g., about 1 second (sec), 0.5 sec, 100 milliseconds (ms), 50 ms, 10 ms, 1 ms or less), then the light source shines light of a second wavelength or a second light emission of a relatively narrow bandwidth (e.g., by having on only the intensity of the second wavelength or the second light emission of a relatively narrow bandwidth or by using a filter that filters out all the other output wavelength(s) or light emission(s) and transmits only the second wavelength or the second light emission of a relatively narrow bandwidth) across each separation channel from the same side of the array of separation channel(s) for a period of time (e.g., about 1 sec, 0.5 sec, 100 ms, 50 ms, 10 ms, 1 ms or less), and so on depending on the number of excitation wavelengths or excitation light transmissions of the light source and the desired number of cycles of illumination.

In other embodiments, the light source (e.g., a laser) has a non-scanning, staring configuration. In certain embodiments, the light source shines light of a first wavelength or a first light emission of a relatively narrow bandwidth (e.g., by having on only the intensity of the first wavelength or the first light emission of a relatively narrow bandwidth or by using a filter that filters out all the other output wavelength(s) or light emission(s) and transmits only the first wavelength or the first light emission of a relatively narrow bandwidth) at a mirror or lens at one side of an array of one or more separation channels for a period of time (e.g., about 1 sec, 0.5 sec, 100 ms, 50 ms, 10 ms, 1 ms or less), the light of the first wavelength or the first light emission of a relatively narrow bandwidth reflects off the mirror or lens across each of the one or more separation channels, then the light source shines light of a second wavelength or a second light emission of a relatively narrow bandwidth (e.g., by having on only the intensity of the second wavelength or the second light emission of a relatively narrow bandwidth or by using a filter that filters out all the other output wavelength(s) or light emission(s) and transmits only the second wavelength or the second light emission of a relatively narrow bandwidth) at the same mirror or lens for a period of time (e.g., about 1 sec, 0.5 sec, 100 ms, 50 ms, 10 ms, 1 ms or less), the light of the second wavelength or the second light emission of a relatively narrow bandwidth reflects off the mirror or lens across each of the one or more separation channels, and so on depending on the number of excitation wavelengths or excitation light emissions of the light source and the desired number of cycles of illumination. By modulating the intensity of each of the output wavelengths or light emissions of a relatively narrow bandwidth to be on at different times or by using a filter that transmits only one output wavelength or light emission of a relatively narrow bandwidth at a given time, the light source can illuminate the interior of each of the one or more separation channels with a single wavelength or a single light emission of a relatively narrow bandwidth at a given time in the non-scanning, non-staring configuration or the non-scanning, staring configuration.

In other embodiments, a different detector or sensor is locked onto the frequency of intensity modulation of each different output wavelength or light emission of a relatively narrow bandwidth of the light source, where the light source can have a scanning or non-scanning configuration. By being locked onto the frequency of intensity modulation of a particular output wavelength or light emission of a relatively narrow bandwidth, a particular detector or sensor collects mostly, or only, fluorescence emission signals induced by that output wavelength or that light emission of a relatively narrow bandwidth.

Further embodiments of the disclosure relate to a device configured to perform the method of separating and detecting dye-labeled nucleic acid fragments using a single light source as described herein. In some embodiments, the device comprises:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a single light source configured to excite each of the plurality of spectrally resolvable fluorescent dyes in each of the one or more separation channels separating a set of dye-labeled nucleic acid fragments produced from a sample,
wherein in some embodiments the light source scans across the interior of each of the one or more separation channels in the on mode, and the light source scans across the exterior of each of the one or more separation channels in the off mode; and

a detector configured to detect light emitted by each of the plurality of excited dyes in each of the one or more separation channels separating a set of dye-labeled nucleic acid fragments produced from a sample.

Whether the light source has a single output wavelength or a single light emission of a relatively narrow bandwidth that excites a plurality of spectrally resolvable dyes or has multiple (e.g., two) output wavelengths or light emissions of a relatively narrow bandwidth that each excite one or more spectrally resolvable dyes, in some embodiments the light source scans across each of the one or more separation channels with on/off modulation of the intensity of each of the one or more output wavelengths or light emissions of a relatively narrow bandwidth or with the use of a filter that transmits a single output wavelength or a single light emission of a relatively narrow bandwidth at a given time, as described herein. If the light source has multiple (e.g., two) output wavelengths or light emissions of a relatively narrow bandwidth that each excite one or more spectrally resolvable dyes, in other embodiments the light source has a non-scanning, non-staring configuration or a non-scanning, staring configuration, wherein the output wavelengths or the light emissions of a relatively narrow bandwidth are intensity-modulated to illuminate at different times, or a filter that transmits a single output wavelength or a single light emission of a relatively narrow bandwidth at a given time is utilized, as described herein. In further embodiments, a separate detector or sensor is locked onto the frequency of intensity modulation of each different output wavelength or light emission of a relatively narrow bandwidth of the light source, where the light source can have a scanning or non-scanning configuration.

The device comprises a detection system or optical assembly comprising the light source and the detector. The light source can be any light source capable of outputting one or more light emissions of a relatively narrow bandwidth, e.g., no more than ±about 30, 25, 20, 15, 10, 5, 3 or 1 nm of the selected output wavelength or the maximum output wavelength of a given light emission. The light source can be, e.g., a laser, an LED, a lamp with a relatively narrow filter, or a flash lamp with a relatively narrow filter. In an embodiment, the light source is a laser. The detector can be any detector or sensor capable of detecting light emitted by each of the plurality of excited dyes in each of the one or more separation channels separating a set of dye-labeled nucleic acid fragments produced from a sample. The detector can comprise, e.g., a CCD camera, a CMOS camera, a photomultiplier tube or a photodiode sensor.

The detection system or optical assembly can further comprise an optical element (e.g., an objective lens) that directs or focuses one or more light emissions from the light source to the interior of each of the one or more separation channels, and elements that collect fluorescence emissions from each separation channel separating a set of dye-labeled nucleic acid fragments produced from a sample and direct the fluorescence emissions to the detector. If the light source has a scanning configuration, the detection system or optical assembly can comprise a scanning assembly that comprises a motor configured to move the light source and/or an optical element (e.g., an objective lens) so that one or more light emissions from the light source scan across the interior of each of the one or more separation channels.

In addition to one or more separation channels, the electrophoresis system of the device can comprise other elements for performing electrophoresis. For example, the electrophoresis system can comprise a power supply configured to supply voltage to each of the one or more separation channels, e.g., by means of electrodes. The electrophoresis system can also comprise an injector configured to inject dye-labeled nucleic acid fragments into each separation channel separating a set of dye-labeled fragments produced from a sample. The electrophoresis system can further comprise a temperature-control element configured to control the temperature of each of the one or more separation channels—e.g., temperature-controlled air, a temperature-controlled surface, an oven, or a metal (e.g., copper) wire in contact with or in close proximity to each separation channel.

In additional embodiments, the device further comprises an analysis system configured to create a computer-readable profile of each set of dye-labeled nucleic acid fragments produced from a sample and subjected to separation and detection. The analysis system can receive data (e.g., signals) about the separation and detection of the dye-labeled fragments from the detection system and can comprise software or computer-executable code that processes and transforms the data into, e.g., electrophoretic traces. The software or code can analyze the data, e.g., to identify and/or to quantify or size a dye-labeled fragment (e.g., an allele of an STR locus). For example, the analysis system can comprise a computer and computer-executable code which determine one or more, or all, genetic loci from which one or more, or all, dye-labeled nucleic acid fragments in each set of dye-labeled fragments produced from a sample are derived, and which determine one or more, or all, allelic forms of the one or more, or all, determined genetic loci.

The device can also comprise any components for preparing and processing the one or more sets of dye-labeled nucleic acid fragments produced from one or more samples prior to their separation by electrophoresis. In some embodiments, the device further comprises a PCR amplification system configured to perform PCR amplification on nucleic acid obtained from each of the one or more samples to produce the one or more sets of dye-labeled nucleic acid fragments produced from one or more samples. In additional embodiments, the device further comprises a nucleic acid extraction and isolation system configured to extract nucleic acid from each of the one or more samples and to isolate the extracted nucleic acid.

In some embodiments, the device is portable or fits in a portable container. In certain embodiments, the device fits in a portable container (e.g., a case or bag) that can be carried by hand, by the shoulder or on the back by one or more people. In further embodiments, the device is transportable to the site where the one or more samples are collected.

The device for separating and detecting dye-labeled nucleic acid fragments using a single light source can comprise components of devices, systems and instruments described in, e.g., U.S. 61/691,242.

### Exemplary Embodiments

The following embodiments of the disclosure are provided by way of example only:

1. A method of separating and detecting nucleic acid fragments, comprising:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

exciting the plurality of spectrally resolvable fluorescent dyes in each of the one or more separation channels separating a set of dye-labeled nucleic acid fragments produced from a sample with light emitted by a plurality of light sources,
wherein each of the plurality of dyes is excited, and
wherein light emitted by each of the plurality of light sources is spatially separated from light emitted by any of the other light source(s) at any given time; and

detecting with a detector light emitted by each of the plurality of excited dyes in each of the one or more separation channels separating a set of dye-labeled nucleic acid fragments produced from a sample.

2. The method of embodiment 1, wherein the electrophoresis system comprises one separation channel.
3. The method of embodiment 2, which comprises separating one set of nucleic acid fragments labeled with a plurality of spectrally resolvable fluorescent dyes and produced from a sample.
4. The method of embodiment 1, wherein the electrophoresis system comprises a plurality of separation channels.
5. The method of embodiment 4, wherein the electrophoresis system comprises 8 or more separation channels.
6. The method of embodiment 4 or 5, wherein the electrophoresis system comprises a substantially planar array of the plurality of separation channels.
7. The method of any one of embodiments 4 to 6, wherein the plurality of separation channels are comprised in a common substrate.
8. The method of any one of embodiments 4 to 7, which comprises separating a plurality of sets of dye-labeled nucleic acid fragments produced from a plurality of samples.
9. The method of any one of embodiments 1 to 8, wherein no two light sources illuminate the same point of any one of the one or more separation channels at a given time.
10. The method of any one of embodiments 1 to 9, wherein each of the plurality of light sources illuminates a spatially different point of the one or more separation channels at a given time.
11. The method of any one of embodiments 1 to 10, wherein exciting the plurality of dyes in each of the one or more separation channels separating a set of dye-labeled nucleic acid fragments produced from a sample comprises scanning light emitted by each of the plurality of light sources across the interior of each of the one or more separation channels when each of the plurality of light sources is in the on mode.
12. The method of embodiment 11, wherein scanning light emitted by each of the plurality of light sources comprises moving at least one optical element through which light emitted by each of the plurality of light sources passes such that light emitted by each light source focuses at a different location in the interior of each of the one or more separation channels as the at least one optical element moves across the interior of each separation channel.
13. The method of embodiment 11 or 12, wherein each of the plurality of light sources is scanned across, or the at least one optical element is moved across, the interior of each of the one or more separation channels in a direction substantially perpendicular to the longitudinal direction of the one or more separation channels at the detection region of the one or more separation channels.
14. The method of any one of embodiments 11 to 13, wherein each of the plurality of light sources is scanned across the interior and the exterior of each of the one or more separation channels in substantially the same direction.
15. The method of any one of embodiments 11 to 14, wherein each of the plurality of light sources is scanned across the interior and the exterior of each of the one or more separation channels at a rate of about 1 Hz or greater.
16. The method of embodiment 15, wherein each of the plurality of light sources is scanned across the interior and the exterior of each of the one or more separation channels at a rate of about 2.5 Hz.
17. The method of any one of embodiments 1 to 16, wherein the interior of a given separation channel is illuminated by a single light source at a given time.
18. The method of any one of embodiments 1 to 17, wherein each of the one or more separation channels is a capillary.
19. The method of embodiment 18, wherein each of the one or more capillaries has an inner diameter (ID) of about 50 microns to about 100 microns and an outer diameter (OD) of about 150 microns to about 200 microns.
20. The method of embodiment 18 or 19, wherein each of the one or more capillaries has an OD/ID ratio of about 2 or greater.
21. The method of any one of embodiments 18 to 20, wherein:

the electrophoresis system comprises a substantially planar array of a plurality of capillaries;

each of the plurality of capillaries contacts at least one other capillary;

each of the plurality of capillaries has an OD/ID ratio of about 2 or greater; and

light emitted by a light source is spatially separated from light emitted by an adjacent light source by a distance from about ID to about (OD-ID).

22. The method of embodiment 18 or 19, wherein:

the electrophoresis system comprises a substantially planar array of a plurality of capillaries;

each of the plurality of capillaries contacts at least one other capillary;

each of the plurality of capillaries has an OD/ID ratio of less than about 2; and

light emitted by a light source is spatially separated from light emitted by an adjacent light source by a distance of about OD/2.

23. The method of any one of embodiments 1 to 22, wherein each of the plurality of light sources is in the on mode when the light source scans across the interior of each of the one or more separation channels, and each of the plurality of light sources is in the off mode when the light source scans across the exterior of each of the one or more separation channels.
24. The method of embodiment 23, wherein each of the plurality of light sources has an intensity modulation frequency of about 1 Hz or greater, or about 5 Hz or greater.
25. The method of embodiment 24, wherein each of the plurality of light sources has an intensity modulation frequency of about 20 Hz.
26. The method of any one of embodiments 1 to 25, wherein each of the one or more separation channels has a length to detection region which is not greater than about 1 m.
27. The method of any one of embodiments 1 to 26, wherein each set of dye-labeled nucleic acid fragments produced from a sample comprises dye-labeled DNA fragments.
28. The method of any one of embodiments 1 to 27, wherein each set of dye-labeled nucleic acid fragments produced from a sample comprises dye-labeled fragments which comprise a short tandem repeat (STR) sequence.
29. The method of any one of embodiments 1 to 28, wherein the dye-labeled nucleic acid fragments of each set of dye-labeled nucleic acid fragments produced from a sample are dye-labeled amplicons produced by PCR amplification.
30. The method of embodiment 29, wherein each set of dye-labeled nucleic acid fragments produced from a sample comprises dye-labeled amplicons of a plurality of different genetic loci.
31. The method of embodiment 29 or 30, wherein each set of dye-labeled nucleic acid fragments produced from a sample comprises dye-labeled amplicons of a plurality of different STR loci.
32. The method of any one of embodiments 1 to 31, wherein each set of dye-labeled nucleic acid fragments produced from a sample comprises dye-labeled fragments which independently comprise a sequence of an STR locus selected from the group consisting of CSF1PO, D3S1358, D5S818, D7S820, D8S1179, D13S317, D16S539, D18S51, D21S11, FGA, TH01, TPDX, vWA, Penta D, and Penta E, and wherein each set comprises dye-labeled fragments comprising sequences of a plurality of different STR loci.
33. The method of embodiment 32, wherein each set of dye-labeled nucleic acid fragments produced from a sample comprises dye-labeled fragments comprising sequences of five or more, or six or more, different STR loci.
34. The method of embodiment 32 or 33, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, and vWA.
35. The method of any one of embodiments 32 to 34, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, vWA, Penta D, and Penta E.
36. The method of any one of embodiments 32 to 35, wherein the dye-labeled fragments comprising an STR sequence comprise from about 12 bases (for single-stranded fragments)/12 base pairs (for double-stranded fragments) to about 186 bases (for single-stranded fragments)/186 base pairs (for double-stranded fragments).
37. The method of any one of embodiments 32 to 36, wherein each set of dye-labeled nucleic acid fragments produced from a sample further comprises a dye-labeled fragment which comprises a sequence of amelogenin.
38. The method of any one of embodiments 1 to 37, wherein each set of dye-labeled nucleic acid fragments produced from a sample comprises dye-labeled amplicons of at least 5, 6, 9, 10 or 11 different polymorphic genetic loci of a species, wherein:

each of the at least 5, 6, 9, 10 or 11 different polymorphic genetic loci of different members of the species can be amplified to produce dye-labeled amplicons within a certain size range;

dye-labeled amplicons of each of the at least 5, 6, 9, 10 or 11 different polymorphic genetic loci are labeled with a different spectrally resolvable fluorescent dye; and

the size ranges of dye-labeled amplicons of the at least 5, 6, 9, 10 or 11 different polymorphic genetic loci at least partially overlap one another.

39. The method of any one of embodiments 1 to 38, wherein each of the dye-labeled nucleic acid fragments of each set of dye-labeled nucleic acid fragments produced from a sample comprises no more than about 350 bases (for single-stranded fragments)/350 base pairs (for double-stranded fragments).
40. The method of any one of embodiments 1 to 39, wherein the dye-labeled nucleic acid fragments of each set of dye-labeled nucleic acid fragments produced from a sample comprise genetic sequences of one or more organisms selected from the group consisting of animals, mammals, humans, plants, pathogens, microbes, bacteria, fungi, and viruses.
41. The method of embodiment 40, wherein the dye-labeled nucleic acid fragments of at least one set, or each set, of the one or more sets of dye-labeled nucleic acid fragments produced from one or more samples comprise genetic sequences of a plurality of different pathogens.
42. The method of any one of embodiments 1 to 40, which comprises separating a plurality of sets of dye-labeled nucleic acid fragments produced from a plurality of human samples, wherein each set of dye-labeled nucleic acid fragments is produced from a different human sample.
43. The method of embodiment 42, wherein the plurality of sets of dye-labeled nucleic acid fragments comprise genetic sequences of a plurality of humans, and wherein each set of dye-labeled nucleic acid fragments comprises genetic sequences of a different human.
44. The method of any one of embodiments 1 to 43, wherein each of the plurality of light sources outputs one or more light emissions having a relatively narrow bandwidth.
45. The method of any one of embodiments 1 to 44, wherein each of the plurality of light sources emits light of a different wavelength.
46. The method of any one of embodiments 1 to 45, wherein each of the plurality of light sources emits light that excites a different subset of the plurality of spectrally resolvable fluorescent dyes in each of the one or more separation channels separating a set of dye-labeled nucleic acid fragments produced from a sample, wherein a subset of dyes comprises one or more dyes.
47. The method of any one of embodiments 1 to 46, wherein the plurality of light sources are two light sources.
48. The method of any one of embodiments 1 to 47, wherein each of the plurality of light sources emits one or more wavelengths of light in the ultraviolet region, the violet region, the blue region, the green region, the yellow region, the orange region, the red region, or the infra-red region of the light spectrum, or a combination thereof.
49. The method of any one of embodiments 1 to 48, wherein each of the plurality of light sources emits one or more wavelengths of light selected from the group consisting of about 350 nm, about 375 nm, about 405 nm, about 430 nm, about 445 nm, about 488 nm, about 514 nm, about 532 nm, about 546 nm, about 552 nm, about 568 nm, about 594 nm, about 610 nm, about 637 nm, about 640 nm, about 647 nm, about 650 nm, about 655 nm, about 660 nm, about 680 nm, about 685 nm, about 700 nm, about 730 nm, about 750 nm, about 785 nm, and about 800 nm.
50. The method of embodiment 49, wherein the plurality of light sources emit light having wavelengths of about 488 nm and about 650 nm.
51. The method of any one of embodiments 1 to 50, wherein each of the plurality of light sources is selected from the group consisting of lasers, light-emitting diodes, lamps having a relatively narrow filter, and flash lamps having a relatively narrow filter.
52. The method of embodiment 51, wherein each of the plurality of light sources is a laser.
53. The method of embodiment 52, wherein each of the plurality of lasers emits light of a single wavelength or two wavelengths.
54. The method of any one of embodiments 1 to 53, wherein each of the plurality of spectrally resolvable fluorescent dyes labels a different nucleic acid fragment in each set of dye-labeled nucleic acid fragments produced from a sample.
55. The method of any one of embodiments 1 to 54, wherein the plurality of spectrally resolvable fluorescent dyes comprise 5 or more, or 6 or more, spectrally resolvable fluorescent dyes.
56. The method of embodiment 55, wherein the plurality of spectrally resolvable fluorescent dyes are 7, 8, 9, 10 or 11 spectrally resolvable fluorescent dyes.
57. The method of any one of embodiments 1 to 56, wherein the detector comprises a CCD camera, a CMOS camera, a photomultiplier tube or a photodiode sensor.
58. The method of any one of embodiments 1 to 57, wherein each set of dye-labeled nucleic acid fragments produced from a sample is separated in a single run.
59. The method of any one of embodiments 1 to 58, which further comprises creating a profile of each set of dye-labeled nucleic acid fragments produced from a sample and subjected to separation and detection.
60. The method of any one of embodiments 1 to 59, which further comprises using a computer and computer-executable code to determine one or more, or all, genetic loci from which one or more, or all, dye-labeled nucleic acid fragments in each set of dye-labeled nucleic acid fragments produced from a sample are derived.
61. The method of embodiment 60, which further comprises using the computer and computer-executable code to determine one or more, or all, allelic forms of the one or more, or all, determined genetic loci.
62. The method of any one of embodiments 1 to 61, which further comprises, prior to separating, performing PCR amplification on nucleic acid obtained from each of the one or more samples to produce the one or more sets of dye-labeled nucleic acid fragments produced from one or more samples.
63. The method of embodiment 62, which further comprises, prior to performing PCR amplification, extracting nucleic acid from each of the one or more samples and isolating the extracted nucleic acid.
64. The method of embodiment 63, wherein isolating the extracted nucleic acid comprises covalently or non-covalently binding the extracted nucleic acid to capture particles.
65. The method of embodiment 64, wherein the capture particles are magnetic particles.
66. The method of any one of embodiments 63 to 65, wherein the extracted nucleic acid is DNA.
67. A device comprising:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a plurality of light sources configured to excite the plurality of spectrally resolvable fluorescent dyes in each of the one or more separation channels separating a set of dye-labeled nucleic acid fragments produced from a sample,
wherein each of the plurality of dyes is excited, and
wherein each of the plurality of light sources emits light which is spatially separated from light emitted by any of the other light source(s) at any given time; and

a detector configured to detect light emitted by each of the plurality of excited dyes in each of the one or more separation channels separating a set of dye-labeled nucleic acid fragments produced from a sample.

68. The device of embodiment 67, wherein the electrophoresis system comprises one separation channel.
69. The device of embodiment 68, wherein the electrophoresis system is configured to separate one set of nucleic acid fragments labeled with a plurality of spectrally resolvable fluorescent dyes and produced from a sample.
70. The device of embodiment 67, wherein the electrophoresis system comprises a plurality of separation channels.
71. The device of embodiment 70, wherein the electrophoresis system comprises 8 or more separation channels.
72. The device of embodiment 70 or 71, wherein the electrophoresis system comprises a substantially planar array of the plurality of separation channels.
73. The device of any one of embodiments 70 to 72, wherein the plurality of separation channels are comprised in a common substrate.
74. The device of any one of embodiments 70 to 73, wherein the electrophoresis system is configured to separate a plurality of sets of dye-labeled nucleic acid fragments produced from a plurality of samples.
75. The device of any one of embodiments 67 to 74, wherein no two light sources illuminate the same point of any one of the one or more separation channels at a given time.
76. The device of any one of embodiments 67 to 75, wherein each of the plurality of light sources illuminates a spatially different point of the one or more separation channels at a given time.
77. The device of any one of embodiments 67 to 76, wherein each of the plurality of light sources scans across the interior of each of the one or more separation channels in the on mode to excite the plurality of spectrally resolvable fluorescent dyes in each of the one or more separation channels separating a set of dye-labeled nucleic acid fragments produced from a sample.
78. The device of embodiment 77, wherein each of the plurality of light sources scans across the interior of each of the one or more separation channels in a direction substantially perpendicular to the longitudinal direction of the one or more separation channels at the detection region of the one or more separation channels.
79. The device of embodiment 77 or 78, wherein each of the plurality of light sources scans across the interior and the exterior of each of the one or more separation channels in substantially the same direction.
80. The device of any one of embodiments 77 to 79, wherein each of the plurality of light sources scans across the interior and the exterior of each of the one or more separation channels at a rate of about 1 Hz or greater.
81. The device of embodiment 80, wherein each of the plurality of light sources scans across the interior and the exterior of each of the one or more separation channels at a rate of about 2.5 Hz.
82. The device of any one of embodiments 67 to 81, wherein the interior of a given separation channel is illuminated by a single light source at a given time.
83. The device of any one of embodiments 67 to 82, wherein each of the one or more separation channels is a capillary.
84. The device of embodiment 83, wherein each of the one or more capillaries has an inner diameter (ID) of about 50 microns to about 100 microns and an outer diameter (OD) of about 150 microns to about 200 microns.
85. The device of embodiment 83 or 84, wherein each of the one or more capillaries has an OD/ID ratio of about 2 or greater.
86. The device of any one of embodiments 83 to 85, wherein:

the electrophoresis system comprises a substantially planar array of a plurality of capillaries;

each of the plurality of capillaries contacts at least one other capillary;

each of the plurality of capillaries has an OD/ID ratio of about 2 or greater; and

light emitted by a light source is spatially separated from light emitted by an adjacent light source by a distance from about ID to about (OD-ID).

87. The device of embodiment 83 or 84, wherein:

the electrophoresis system comprises a substantially planar array of a plurality of capillaries;

each of the plurality of capillaries contacts at least one other capillary;

each of the plurality of capillaries has an OD/ID ratio of less than about 2; and

light emitted by a light source is spatially separated from light emitted by an adjacent light source by a distance of about OD/2.

88. The device of any one of embodiments 67 to 87, wherein each of the plurality of light sources is in the on mode when the light source scans across the interior of each of the one or more separation channels, and each of the plurality of light sources is in the off mode when the light source scans across the exterior of each of the one or more separation channels.
89. The device of embodiment 88, wherein each of the plurality of light sources has an intensity modulation frequency of about 1 Hz or greater, or about 5 Hz or greater.
90. The device of embodiment 89, wherein each of the plurality of light sources has an intensity modulation frequency of about 20 Hz.
91. The device of any one of embodiments 67 to 90, wherein each of the one or more separation channels has a length to detection region which is not greater than about 1 m.
92. The device of any one of embodiments 67 to 91, wherein each set of dye-labeled nucleic acid fragments produced from a sample comprises dye-labeled DNA fragments.
93. The device of any one of embodiments 67 to 92, wherein each set of dye-labeled nucleic acid fragments produced from a sample comprises dye-labeled fragments which comprise a short tandem repeat (STR) sequence.
94. The device of any one of embodiments 67 to 93, wherein the dye-labeled nucleic acid fragments of each set of dye-labeled nucleic acid fragments produced from a sample are dye-labeled amplicons produced by PCR amplification.
95. The device of embodiment 94, wherein each set of dye-labeled nucleic acid fragments produced from a sample comprises dye-labeled amplicons of a plurality of different genetic loci.
96. The device of embodiment 94 or 95, wherein each set of dye-labeled nucleic acid fragments produced from a sample comprises dye-labeled amplicons of a plurality of different STR loci.
97. The device of any one of embodiments 67 to 96, wherein each set of dye-labeled nucleic acid fragments produced from a sample comprises dye-labeled fragments which independently comprise a sequence of an STR locus selected from the group consisting of CSF1PO, D3S1358, D5S818, D7S820, D8S1179, D13S317, D16S539, D18S51, D21S11, FGA, TH01, TPDX, vWA, Penta D, and Penta E, wherein each set comprises dye-labeled fragments comprising sequences of a plurality of different STR loci.
98. The device of embodiment 97, wherein each set of dye-labeled nucleic acid fragments produced from a sample comprises dye-labeled fragments comprising sequences of five or more, or six or more, different STR loci.
99. The device of embodiment 97 or 98, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, and vWA.
100. The device of any one of embodiments 97 to 99, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, vWA, Penta D, and Penta E.
101. The device of any one of embodiments 97 to 100, wherein the dye-labeled fragments comprising an STR sequence comprise from about 12 bases (for single-stranded fragments)/12 base pairs (for double-stranded fragments) to about 186 bases (for single-stranded fragments)/186 base pairs (for double-stranded fragments).
102. The device of any one of embodiments 97 to 101, wherein each set of dye-labeled nucleic acid fragments produced from a sample further comprises a dye-labeled fragment which comprises a sequence of amelogenin.
103. The device of any one of embodiments 67 to 102, wherein each set of dye-labeled nucleic acid fragments produced from a sample comprises dye-labeled amplicons of at least 5, 6, 9, 10 or 11 different polymorphic genetic loci of a species, wherein:

each of the at least 5, 6, 9, 10 or 11 different polymorphic genetic loci of different members of the species can be amplified to produce dye-labeled amplicons within a certain size range;

dye-labeled amplicons of each of the at least 5, 6, 9, 10 or 11 different polymorphic genetic loci are labeled with a different spectrally resolvable fluorescent dye; and

the size ranges of dye-labeled amplicons of the at least 5, 6, 9, 10 or 11 different polymorphic genetic loci at least partially overlap one another.

104. The device of any one of embodiments 67 to 103, wherein each of the dye-labeled nucleic acid fragments of each set of dye-labeled nucleic acid fragments produced from a sample comprises no more than about 350 bases (for single-stranded fragments)/350 base pairs (for double-stranded fragments).
105. The device of any one of embodiments 67 to 104, wherein the dye-labeled nucleic acid fragments of each set of dye-labeled nucleic acid fragments produced from a sample comprise genetic sequences of one or more organisms selected from the group consisting of animals, mammals, humans, plants, pathogens, microbes, bacteria, fungi, and viruses.
106. The device of embodiment 105, wherein the dye-labeled nucleic acid fragments of at least one set, or each set, of the one or more sets of dye-labeled nucleic acid fragments produced from one or more samples comprise genetic sequences of a plurality of different pathogens.
107. The device of any one of embodiments 67 to 105, wherein the electrophoresis system is configured to separate a plurality of sets of dye-labeled nucleic acid fragments produced from a plurality of human samples, and wherein each set of dye-labeled nucleic acid fragments is produced from a different human sample.
108. The device of embodiment 107, wherein the plurality of sets of dye-labeled nucleic acid fragments comprise genetic sequences of a plurality of humans, and wherein each set of dye-labeled nucleic acid fragments comprises genetic sequences of a different human.
109. The device of any one of embodiments 67 to 108, wherein each of the plurality of light sources outputs one or more light emissions having a relatively narrow bandwidth.
110. The device of any one of embodiments 67 to 109, wherein each of the plurality of light sources emits light of a different wavelength.
111. The device of any one of embodiments 67 to 110, wherein each of the plurality of light sources emits light that excites a different subset of the plurality of spectrally resolvable fluorescent dyes in each of the one or more separation channels separating a set of dye-labeled nucleic acid fragments produced from a sample, wherein a subset of dyes comprises one or more dyes.
112. The device of any one of embodiments 67 to 111, wherein the plurality of light sources are two light sources.
113. The device of any one of embodiments 67 to 112, wherein each of the plurality of light sources emits one or more wavelengths of light in the ultraviolet region, the violet region, the blue region, the green region, the yellow region, the orange region, the red region, or the infra-red region of the light spectrum, or a combination thereof.
114. The device of any one of embodiments 67 to 113, wherein each of the plurality of light sources emits one or more wavelengths of light selected from the group consisting of about 350 nm, about 375 nm, about 405 nm, about 430 nm, about 445 nm, about 488 nm, about 514 nm, about 532 nm, about 546 nm, about 552 nm, about 568 nm, about 594 nm, about 610 nm, about 637 nm, about 640 nm, about 647 nm, about 650 nm, about 655 nm, about 660 nm, about 680 nm, about 685 nm, about 700 nm, about 730 nm, about 750 nm, about 785 nm, and about 800 nm.
115. The device of embodiment 114, wherein the plurality of light sources emit light having wavelengths of about 488 nm and about 650 nm.
116. The device of any one of embodiments 67 to 115, wherein each of the plurality of light sources is selected from the group consisting of lasers, light-emitting diodes, lamps having a relatively narrow filter, and flash lamps having a relatively narrow filter.
117. The device of embodiment 116, wherein each of the plurality of light sources is a laser.
118. The device of embodiment 117, wherein each of the plurality of lasers emits light of a single wavelength or two wavelengths.
119. The device of any one of embodiments 67 to 118, wherein each of the plurality of spectrally resolvable fluorescent dyes labels a different nucleic acid fragment in each set of dye-labeled nucleic acid fragments produced from a sample.
120. The device of any one of embodiments 67 to 119, wherein the plurality of spectrally resolvable fluorescent dyes comprise 5 or more, or 6 or more, spectrally resolvable fluorescent dyes.
121. The device of embodiment 120, wherein the plurality of spectrally resolvable fluorescent dyes are 7, 8, 9, 10 or 11 spectrally resolvable fluorescent dyes.
122. The device of any one of embodiments 67 to 121, wherein the detector comprises a CCD camera, a CMOS camera, a photomultiplier tube or a photodiode sensor.
123. The device of any one of embodiments 67 to 122, wherein the electrophoresis system is configured to separate each set of dye-labeled nucleic acid fragments produced from a sample in a single run.
124. The device of any one of embodiments 67 to 123, which further comprises an analysis system configured to create a profile of each set of dye-labeled nucleic acid fragments produced from a sample and subjected to separation and detection.
125. The device of embodiment 124, wherein the analysis system comprises a computer and computer-executable code configured to determine one or more, or all, genetic loci from which one or more, or all, dye-labeled nucleic acid fragments in each set of dye-labeled nucleic acid fragments produced from a sample are derived.
126. The device of embodiment 125, wherein the computer and computer-executable code are further configured to determine one or more, or all, allelic forms of the one or more, or all, determined genetic loci.
127. The device of any one of embodiments 67 to 126, which further comprises a PCR amplification system configured to perform PCR amplification on nucleic acid obtained from each of the one or more samples to produce the one or more sets of dye-labeled nucleic acid fragments produced from one or more samples.
128. The device of any one of embodiments 67 to 127, which further comprises a nucleic acid extraction and isolation system configured to extract nucleic acid from each of the one or more samples and to isolate the extracted nucleic acid.
129. The device of embodiment 128, wherein the nucleic acid extraction and isolation system comprises capture particles that covalently or non-covalently bind nucleic acid.
130. The device of embodiment 129, wherein the capture particles are magnetic particles.
131. The device of any one of embodiments 128 to 130, wherein the nucleic acid is DNA.
132. The device of any one of embodiments 67 to 131, which is configured to perform the method of any one of embodiments 1 to 66.
133. The device of any one of embodiments 67 to 132, which is portable or fits in a portable container.
134. A method of separating and detecting nucleic acid fragments, comprising:

separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

scanning a single light source across the interior of each of the one or more separation channels in the on mode to excite each of the plurality of spectrally resolvable fluorescent dyes in each of the one or more separation channels separating a set of dye-labeled nucleic acid fragments produced from a sample, and scanning the light source across the exterior of each of the one or more separation channels in the off mode; and

detecting with a detector light emitted by each of the plurality of excited dyes in each of the one or more separation channels separating a set of dye-labeled nucleic acid fragments produced from a sample.

135. The method of embodiment 134, wherein the electrophoresis system comprises one separation channel.
136. The method of embodiment 135, which comprises separating one set of nucleic acid fragments labeled with a plurality of spectrally resolvable fluorescent dyes and produced from a sample.
137. The method of embodiment 134, wherein the electrophoresis system comprises a plurality of separation channels.
138. The method of embodiment 137, wherein the electrophoresis system comprises 8 or more separation channels.
139. The method of embodiment 137 or 138, wherein the electrophoresis system comprises a substantially planar array of the plurality of separation channels.
140. The method of any one of embodiments 137 to 139, wherein the plurality of separation channels are comprised in a common substrate.
141. The method of any one of embodiments 137 to 140, which comprises separating a plurality of sets of dye-labeled nucleic acid fragments produced from a plurality of samples.
142. The method of any one of embodiments 134 to 141, wherein scanning the light source comprises moving an optical element through which light emitted by the light source passes such that light emitted by the light source focuses at a different location in the interior of each of the one or more separation channels as the optical element moves across the interior of each separation channel.
143. The method of any one of embodiments 134 to 142, wherein the light source is scanned across, or the optical element is moved across, the interior of each of the one or more separation channels in a direction substantially perpendicular to the longitudinal direction of the one or more separation channels at the detection region of the one or more separation channels.
144. The method of any one of embodiments 134 to 143, wherein the light source is scanned across the interior and the exterior of each of the one or more separation channels at a rate of about 1 Hz or greater.
145. The method of embodiment 144, wherein the light source is scanned across the interior and the exterior of each of the one or more separation channels at a rate of about 2.5 Hz.
146. The method of any one of embodiments 134 to 145, wherein the light source has an intensity modulation frequency of about 1 Hz or greater, or about 5 Hz or greater.
147. The method of embodiment 146, wherein the light source has an intensity modulation frequency of about 20 Hz.
148. The method of any one of embodiments 134 to 147, wherein each of the one or more separation channels is a capillary.
149. The method of embodiment 148, wherein each of the one or more capillaries has an inner diameter (ID) of about 50 microns to about 100 microns and an outer diameter (OD) of about 150 microns to about 200 microns.
150. The method of embodiment 148 or 149, wherein each of the one or more capillaries has an OD/ID ratio of about 2 or greater.
151. The method of any one of embodiments 134 to 150, wherein each of the one or more separation channels has a length to detection region which is not greater than about 1 m.
152. The method of any one of embodiments 134 to 151, wherein each set of dye-labeled nucleic acid fragments produced from a sample comprises dye-labeled DNA fragments.
153. The method of any one of embodiments 134 to 152, wherein each set of dye-labeled nucleic acid fragments produced from a sample comprises dye-labeled fragments which comprise a short tandem repeat (STR) sequence.
154. The method of any one of embodiments 134 to 153, wherein the dye-labeled nucleic acid fragments of each set of dye-labeled nucleic acid fragments produced from a sample are dye-labeled amplicons produced by PCR amplification.
155. The method of embodiment 154, wherein each set of dye-labeled nucleic acid fragments produced from a sample comprises dye-labeled amplicons of a plurality of different genetic loci.
156. The method of embodiment 154 or 155, wherein each set of dye-labeled nucleic acid fragments produced from a sample comprises dye-labeled amplicons of a plurality of different STR loci.
157. The method of any one of embodiments 134 to 156, wherein each set of dye-labeled nucleic acid fragments produced from a sample comprises dye-labeled fragments which independently comprise a sequence of an STR locus selected from the group consisting of CSF1PO, D3S1358, D5S818, D7S820, D8S1179, D13S317, D16S539, D18S51, D21S11, FGA, TH01, TPDX, vWA, Penta D, and Penta E, wherein each set comprises dye-labeled fragments comprising sequences of a plurality of different STR loci.
158. The method of embodiment 157, wherein each set of dye-labeled nucleic acid fragments produced from a sample comprises dye-labeled fragments comprising sequences of five or more, or six or more, different STR loci.
159. The method of embodiment 157 or 158, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, and vWA.
160. The method of any one of embodiments 157 to 159, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, vWA, Penta D, and Penta E.
161. The method of any one of embodiments 157 to 160, wherein the dye-labeled fragments comprising an STR sequence comprise from about 12 bases (for single-stranded fragments)/12 base pairs (for double-stranded fragments) to about 186 bases (for single-stranded fragments)/186 base pairs (for double-stranded fragments).
162. The method of any one of embodiments 157 to 161, wherein each set of dye-labeled nucleic acid fragments produced from a sample further comprises a dye-labeled fragment which comprises a sequence of amelogenin.
163. The method of any one of embodiments 134 to 162, wherein each of the dye-labeled nucleic acid fragments of each set of dye-labeled nucleic acid fragments produced from a sample comprises no more than about 350 bases (for single-stranded fragments)/350 base pairs (for double-stranded fragments).
164. The method of any one of embodiments 134 to 163, wherein the dye-labeled nucleic acid fragments of each set of dye-labeled nucleic acid fragments produced from a sample comprise genetic sequences of one or more organisms selected from the group consisting of animals, mammals, humans, plants, pathogens, microbes, bacteria, fungi, and viruses.
165. The method of embodiment 164, wherein the dye-labeled nucleic acid fragments of at least one set, or each set, of the one or more sets of dye-labeled nucleic acid fragments produced from one or more samples comprise genetic sequences of a plurality of different pathogens.
166. The method of any one of embodiments 134 to 164, which comprises separating a plurality of sets of dye-labeled nucleic acid fragments produced from a plurality of human samples, wherein each set of dye-labeled nucleic acid fragments is produced from a different human sample.
167. The method of embodiment 166, wherein the plurality of sets of dye-labeled nucleic acid fragments comprise genetic sequences of a plurality of humans, and wherein each set of dye-labeled nucleic acid fragments comprises genetic sequences of a different human.
168. The method of any one of embodiments 134 to 167, wherein the light source outputs one or more light emissions having a relatively narrow bandwidth.
169. The method of any one of embodiments 134 to 168, wherein:

the light source outputs a plurality of light emissions having a relatively narrow bandwidth; and

each of the plurality of light emissions excites a different subset of the plurality of spectrally resolvable fluorescent dyes in each of the one or more separation channels separating a set of dye-labeled nucleic acid fragments produced from a sample, wherein a subset of dyes comprises one or more dyes.

170. The method of any one of embodiments 134 to 169, wherein the light source emits one or more wavelengths of light in the ultraviolet region, the violet region, the blue region, the green region, the yellow region, the orange region, the red region, or the infra-red region of the light spectrum, or a combination thereof.
171. The method of any one of embodiments 134 to 170, wherein the light source emits one or more wavelengths of light selected from the group consisting of about 350 nm, about 375 nm, about 405 nm, about 430 nm, about 445 nm, about 488 nm, about 514 nm, about 532 nm, about 546 nm, about 552 nm, about 568 nm, about 594 nm, about 610 nm, about 637 nm, about 640 nm, about 647 nm, about 650 nm, about 655 nm, about 660 nm, about 680 nm, about 685 nm, about 700 nm, about 730 nm, about 750 nm, about 785 nm, and about 800 nm.
172. The method of embodiment 171, wherein the light source emits light having a wavelength of about 488 nm or having wavelengths of about 488 nm and about 514 nm.
173. The method of any one of embodiments 134 to 172, wherein the light source is a laser, a light-emitting diode, a lamp having a relatively narrow filter, or a flash lamp having a relatively narrow filter.
174. The method of embodiment 173, wherein the light source is a laser.
175. The method of embodiment 174, wherein the laser emits light of a single wavelength or two wavelengths.
176. The method of any one of embodiments 134 to 175, wherein each of the plurality of spectrally resolvable fluorescent dyes labels a different nucleic acid fragment in each set of dye-labeled nucleic acid fragments produced from a sample.
177. The method of any one of embodiments 134 to 176, wherein the plurality of spectrally resolvable fluorescent dyes are 3, 4 or 5 spectrally resolvable fluorescent dyes.
178. The method of any one of embodiments 134 to 177, wherein the detector comprises a CCD camera, a CMOS camera, a photomultiplier tube or a photodiode sensor.
179. The method of any one of embodiments 134 to 178, wherein each set of dye-labeled nucleic acid fragments produced from a sample is separated in a single run.
180. The method of any one of embodiments 134 to 179, which further comprises creating a profile of each set of dye-labeled nucleic acid fragments produced from a sample and subjected to separation and detection.
181. The method of any one of embodiments 134 to 180, which further comprises using a computer and computer-executable code to determine one or more, or all, genetic loci from which one or more, or all, dye-labeled nucleic acid fragments in each set of dye-labeled nucleic acid fragments produced from a sample are derived.
182. The method of embodiment 181, which further comprises using the computer and computer-executable code to determine one or more, or all, allelic forms of the one or more, or all, determined genetic loci.
183. The method of any one of embodiments 134 to 182, which further comprises, prior to separating, performing PCR amplification on nucleic acid obtained from each of the one or more samples to produce the one or more sets of dye-labeled nucleic acid fragments produced from one or more samples.
184. The method of embodiment 183, which further comprises, prior to performing PCR amplification, extracting nucleic acid from each of the one or more samples and isolating the extracted nucleic acid.
185. The method of embodiment 184, wherein isolating the extracted nucleic acid comprises covalently or non-covalently binding the extracted nucleic acid to capture particles.
186. The method of embodiment 185, wherein the capture particles are magnetic particles.
187. The method of any one of embodiments 184 to 186, wherein the extracted nucleic acid is DNA.
188. A device comprising:

an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;

a single light source configured to excite each of the plurality of spectrally resolvable fluorescent dyes in each of the one or more separation channels separating a set of dye-labeled nucleic acid fragments produced from a sample,
wherein the light source is in the on mode when the light source scans across the interior of each of the one or more separation channels, and
wherein the light source is in the off mode when the light source scans across the exterior of each of the one or more separation channels; and

a detector configured to detect light emitted by each of the plurality of excited dyes in each of the one or more separation channels separating a set of dye-labeled nucleic acid fragments produced from a sample.

189. The device of embodiment 188, wherein the electrophoresis system comprises one separation channel.
190. The device of embodiment 189, wherein the electrophoresis system is configured to separate one set of nucleic acid fragments labeled with a plurality of spectrally resolvable fluorescent dyes and produced from a sample.
191. The device of embodiment 188, wherein the electrophoresis system comprises a plurality of separation channels.
192. The device of embodiment 191, wherein the electrophoresis system comprises 8 or more separation channels.
193. The device of embodiment 191 or 192, wherein the electrophoresis system comprises a substantially planar array of the plurality of separation channels.
194. The device of any one of embodiments 191 to 193, wherein the plurality of separation channels are comprised in a common substrate.
195. The device of any one of embodiments 191 to 194, wherein the electrophoresis system is configured to separate a plurality of sets of dye-labeled nucleic acid fragments produced from a plurality of samples.
196. The device of any one of embodiments 188 to 195, wherein the light source scans across the interior of each of the one or more separation channels in a direction substantially perpendicular to the longitudinal direction of the one or more separation channels at the detection region of the one or more separation channels.
197. The device of any one of embodiments 188 to 196, wherein the light source scans across the interior and the exterior of each of the one or more separation channels at a rate of about 1 Hz or greater.
198. The device of embodiment 197, wherein the light source scans across the interior and the exterior of each of the one or more separation channels at a rate of about 2.5 Hz.
199. The device of any one of embodiments 188 to 198, wherein the light source has an intensity modulation frequency of about 1 Hz or greater, or about 5 Hz or greater.
200. The device of embodiment 199, wherein the light source has an intensity modulation frequency of about 20 Hz.
201. The device of any one of embodiments 188 to 200, wherein each of the one or more separation channels is a capillary.
202. The device of embodiment 201, wherein each of the one or more capillaries has an inner diameter (ID) of about 50 microns to about 100 microns and an outer diameter (OD) of about 150 microns to about 200 microns.
203. The device of embodiment 201 or 202, wherein each of the one or more capillaries has an OD/ID ratio of about 2 or greater.
204. The device of any one of embodiments 188 to 203, wherein each of the one or more separation channels has a length to detection region which is not greater than about 1 m.
205. The device of any one of embodiments 188 to 204, wherein each set of dye-labeled nucleic acid fragments produced from a sample comprises dye-labeled DNA fragments.
206. The device of any one of embodiments 188 to 205, wherein each set of dye-labeled nucleic acid fragments produced from a sample comprises dye-labeled fragments which comprise a short tandem repeat (STR) sequence.
207. The device of any one of embodiments 188 to 206, wherein the dye-labeled nucleic acid fragments of each set of dye-labeled nucleic acid fragments produced from a sample are dye-labeled amplicons produced by PCR amplification.
208. The device of embodiment 207, wherein each set of dye-labeled nucleic acid fragments produced from a sample comprises dye-labeled amplicons of a plurality of different genetic loci.
209. The device of embodiment 207 or 208, wherein each set of dye-labeled nucleic acid fragments produced from a sample comprises dye-labeled amplicons of a plurality of different STR loci.
210. The device of any one of embodiments 188 to 209, wherein each set of dye-labeled nucleic acid fragments produced from a sample comprises dye-labeled fragments which independently comprise a sequence of an STR locus selected from the group consisting of CSF1PO, D3S1358, D5S818, D7S820, D8S1179, D13S317, D16S539, D18S51, D21S11, FGA, TH01, TPDX, vWA, Penta D, and Penta E, wherein each set comprises dye-labeled fragments comprising sequences of a plurality of different STR loci.
211. The device of embodiment 210, wherein each set of dye-labeled nucleic acid fragments produced from a sample comprises dye-labeled fragments comprising sequences of five or more, or six or more, different STR loci.
212. The device of embodiment 210 or 211, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, and vWA.
213. The device of any one of embodiments 210 to 212, wherein each set of dye-labeled nucleic acid fragments produced from a sample comprises dye-labeled fragments which independently comprise an STR sequence of each one of CSF1PO, D3S1358, D5S818, D7S820, D8S1179, D13S317, D16S539, D18S51, D21S11, FGA, TH01, TPDX, vWA, Penta D, and Penta E.
214. The device of any one of embodiments 210 to 213, wherein the dye-labeled fragments comprising an STR sequence comprise from about 12 bases (for single-stranded fragments)/12 base pairs (for double-stranded fragments) to about 186 bases (for single-stranded fragments)/186 base pairs (for double-stranded fragments).
215. The device of any one of embodiments 210 to 214, wherein each set of dye-labeled nucleic acid fragments produced from a sample further comprises a dye-labeled fragment which comprises a sequence of amelogenin.
216. The device of any one of embodiments 188 to 215, wherein each of the dye-labeled nucleic acid fragments of each set of dye-labeled nucleic acid fragments produced from a sample comprises no more than about 350 bases (for single-stranded fragments)/350 base pairs (for double-stranded fragments).
217. The device of any one of embodiments 188 to 216, wherein the dye-labeled nucleic acid fragments of each set of dye-labeled nucleic acid fragments produced from a sample comprise genetic sequences of one or more organisms selected from the group consisting of animals, mammals, humans, plants, pathogens, microbes, bacteria, fungi, and viruses.
218. The device of embodiment 217, wherein the dye-labeled nucleic acid fragments of at least one set, or each set, of the one or more sets of dye-labeled nucleic acid fragments produced from one or more samples comprise genetic sequences of a plurality of different pathogens.
219. The device of any one of embodiments 188 to 217, wherein the electrophoresis system is configured to separate a plurality of sets of dye-labeled nucleic acid fragments produced from a plurality of human samples, and wherein each set of dye-labeled nucleic acid fragments is produced from a different human sample.
220. The device of embodiment 219, wherein the plurality of sets of dye-labeled nucleic acid fragments comprise genetic sequences of a plurality of humans, and wherein each set of dye-labeled nucleic acid fragments comprises genetic sequences of a different human.
221. The device of any one of embodiments 188 to 220, wherein the light source outputs one or more light emissions having a relatively narrow bandwidth.
222. The device of any one of embodiments 188 to 221, wherein:

the light source outputs a plurality of light emissions having a relatively narrow bandwidth; and

each of the plurality of light emissions excites a different subset of the plurality of spectrally resolvable fluorescent dyes in each of the one or more separation channels separating a set of dye-labeled nucleic acid fragments produced from a sample, wherein a subset of dyes comprises one or more dyes.

223. The device of any one of embodiments 188 to 222, wherein the light source emits one or more wavelengths of light in the ultraviolet region, the violet region, the blue region, the green region, the yellow region, the orange region, the red region, or the infra-red region of the light spectrum, or a combination thereof.
224. The device of any one of embodiments 188 to 223, wherein the light source emits one or more wavelengths of light selected from the group consisting of about 350 nm, about 375 nm, about 405 nm, about 430 nm, about 445 nm, about 488 nm, about 514 nm, about 532 nm, about 546 nm, about 552 nm, about 568 nm, about 594 nm, about 610 nm, about 637 nm, about 640 nm, about 647 nm, about 650 nm, about 655 nm, about 660 nm, about 680 nm, about 685 nm, about 700 nm, about 730 nm, about 750 nm, about 785 nm, and about 800 nm.
225. The device of embodiment 224, wherein the light source emits light having a wavelength of about 488 nm or having wavelengths of about 488 nm and about 514 nm.
226. The device of any one of embodiments 188 to 225, wherein the light source is a laser, a light-emitting diode, a lamp having a relatively narrow filter, or a flash lamp having a relatively narrow filter.
227. The device of embodiment 226, wherein the light source is a laser.
228. The device of embodiment 227, wherein the laser emits light of a single wavelength or two wavelengths.
229. The device of any one of embodiments 188 to 228, wherein each of the plurality of spectrally resolvable fluorescent dyes labels a different nucleic acid fragment in each set of dye-labeled nucleic acid fragments produced from a sample.
230. The device of any one of embodiments 188 to 229, wherein the plurality of spectrally resolvable fluorescent dyes are 3, 4 or 5 spectrally resolvable fluorescent dyes.
231. The device of any one of embodiments 188 to 230, wherein the detector comprises a CCD camera, a CMOS camera, a photomultiplier tube or a photodiode sensor.
232. The device of any one of embodiments 188 to 231, wherein the electrophoresis system is configured to separate each set of dye-labeled nucleic acid fragments produced from a sample in a single run.
233. The device of any one of embodiments 188 to 232, which further comprises an analysis system configured to create a profile of each set of dye-labeled nucleic acid fragments produced from a sample and subjected to separation and detection.
234. The device of embodiment 233, wherein the analysis system comprises a computer and computer-executable code configured to determine one or more, or all, genetic loci from which one or more, or all, dye-labeled nucleic acid fragments in each set of dye-labeled nucleic acid fragments produced from a sample are derived.
235. The device of embodiment 234, wherein the computer and computer-executable code are further configured to determine one or more, or all, allelic forms of the one or more, or all, determined genetic loci.
236. The device of any one of embodiments 188 to 235, which further comprises a PCR amplification system configured to perform PCR amplification on nucleic acid obtained from each of the one or more samples to produce the one or more sets of dye-labeled nucleic acid fragments produced from one or more samples.
237. The device of any one of embodiments 188 to 236, which further comprises a nucleic acid extraction and isolation system configured to extract nucleic acid from each of the one or more samples and to isolate the extracted nucleic acid.
238. The device of embodiment 237, wherein the nucleic acid extraction and isolation system comprises capture particles that covalently or non-covalently bind nucleic acid.
239. The device of embodiment 238, wherein the capture particles are magnetic particles.
240. The device of any one of embodiments 237 to 239, wherein the nucleic acid is DNA.
241. The device of any one of embodiments 188 to 240, which is configured to perform the method of any one of embodiments 134 to 187.
242. The device of any one of embodiments 188 to 241, which is portable or fits in a portable container.

It is understood that, while particular embodiments have been illustrated and described, various modifications may be made thereto and are contemplated herein. It is also understood that the disclosure is not limited by the specific examples provided herein. The descriptions and illustrations of embodiments and examples of the disclosure herein are not intended to be construed in a limiting sense. It is further understood that all aspects of the disclosure are not limited to the specific depictions, configurations or relative proportions set forth herein, which may depend upon a variety of conditions and variables. Various modifications and variations in form and detail of the embodiments and examples of the disclosure will be apparent to a person skilled in the art. It is therefore contemplated that the disclosure also covers any and all such modifications, variations and equivalents.

1. A method of separating and detecting nucleic acid fragments, comprising:
separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;
exciting the plurality of spectrally resolvable fluorescent dyes in each of the one or more separation channels separating a set of dye-labeled nucleic acid fragments produced from a sample with light emitted by a plurality of light sources,
wherein each of the plurality of dyes is excited, and
wherein light emitted by each of the plurality of light sources is spatially separated from light emitted by any of the other light source(s) at any given time; and
detecting with a detector light emitted by each of the plurality of excited dyes in each of the one or more separation channels separating a set of dye-labeled nucleic acid fragments produced from a sample.

2. The method of claim 1, wherein each of the plurality of light sources emits light having a bandwidth no more than ±about 20 nm of the selected output wavelength.

3. The method of claim 1, wherein each of the plurality of light sources is a laser.

4. The method of claim 1, wherein each of the plurality of light sources emits light that excites a different subset of the plurality of spectrally resolvable fluorescent dyes in each of the one or more separation channels separating a set of dye-labeled nucleic acid fragments produced from a sample, wherein a subset of dyes comprises one or more dyes.

5. The method of claim 1, wherein the plurality of light sources are two light sources, and the plurality of spectrally resolvable fluorescent dyes in each set of dye-labeled nucleic acid fragments produced from a sample comprise five or more, or six or more, spectrally resolvable fluorescent dyes.

6. The method of claim 1, wherein the electrophoresis system comprises a plurality of separation channels, and wherein the method comprises separating a plurality of sets of dye-labeled nucleic acid fragments produced from a plurality of samples.

7. The method of claim 6, wherein the electrophoresis system comprises a capillary array electrophoresis system.

8. The method of claim 1, wherein the interior of a given separation channel is illuminated by a single light source at a given time.

9. The method of claim 1, wherein each of the plurality of light sources is in the on mode when the light source scans across the interior of each of the one or more separation channels, and each of the plurality of light sources is in the off mode when the light source scans across the exterior of each of the one or more separation channels.

10. The method of claim 1, wherein each set of dye-labeled nucleic acid fragments produced from a sample comprises dye-labeled amplicons of a plurality of different short tandem repeat (STR) loci.

11. The method of claim 10, wherein each set of dye-labeled nucleic acid fragments produced from a sample comprises dye-labeled amplicons which independently comprise a sequence of an STR locus selected from the group consisting of CSF1PO, D3S1358, D5S818, D7S820, D8S1179, D13S317, D16S539, D18S51, D21S11, FGA, TH01, TPDX, vWA, Penta D, and Penta E.

12. The method of claim 10, wherein each set of dye-labeled nucleic acid fragments produced from a sample comprises dye-labeled amplicons of at least five or six different STR loci.

13. The method of claim 1, wherein each set of dye-labeled nucleic acid fragments produced from a sample comprises dye-labeled amplicons of at least five or six different polymorphic genetic loci of a species, wherein:
each of the at least five or six different polymorphic genetic loci of different members of the species can be amplified to produce dye-labeled amplicons within a certain size range;
dye-labeled amplicons of each of the at least five or six different polymorphic genetic loci are labeled with a different spectrally resolvable fluorescent dye; and
the size ranges of dye-labeled amplicons of the at least five or six different polymorphic genetic loci at least partially overlap one another.

14. The method of claim 1, which further comprises creating a profile of each set of dye-labeled nucleic acid fragments produced from a sample and subjected to separation and detection.

15. The method of claim 1, which further comprises, prior to separating, performing PCR amplification on nucleic acid obtained from each of the one or more samples to produce the one or more sets of dye-labeled nucleic acid fragments produced from one or more samples.

16. The method of claim 15, which further comprises, prior to performing PCR amplification, extracting nucleic acid from each of the one or more samples and isolating the extracted nucleic acid.

17. A device comprising:
an electrophoresis system comprising one or more separation channels,
wherein the electrophoresis system is configured to separate one or more sets of dye-labeled nucleic acid fragments produced from one or more samples,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;
a plurality of light sources configured to excite the plurality of spectrally resolvable fluorescent dyes in each of the one or more separation channels separating a set of dye-labeled nucleic acid fragments produced from a sample,
wherein each of the plurality of dyes is excited, and
wherein each of the plurality of light sources emits light which is spatially separated from light emitted by any of the other light source(s) at any given time; and
a detector configured to detect light emitted by each of the plurality of excited dyes in each of the one or more separation channels separating a set of dye-labeled nucleic acid fragments produced from a sample.

18. (canceled)

19. (canceled)

20. The device of claim 17, wherein each of the plurality of light sources comprises a laser and emits light that excites a different subset of the plurality of spectrally resolvable fluorescent dyes in each of the one or more separation channels separating a set of dye-labeled nucleic acid fragments produced from a sample, wherein a subset of dyes comprises one or more dyes.

21. (canceled)

22. (canceled)

23. (canceled)

24. The device of claim 17, wherein the interior of a given separation channel is illuminated by a single light source at a given time.

25-32. (canceled)

33. A method of separating and detecting nucleic acid fragments, comprising:
separating one or more sets of dye-labeled nucleic acid fragments produced from one or more samples using an electrophoresis system comprising one or more separation channels,
wherein each set of the one or more sets of dye-labeled nucleic acid fragments produced from one or more samples is labeled with a plurality of spectrally resolvable fluorescent dyes and is produced from a different sample, and
wherein each set of dye-labeled nucleic acid fragments produced from a different sample is separated in a different separation channel;
scanning a single light source across the interior of each of the one or more separation channels in the on mode to excite each of the plurality of spectrally resolvable fluorescent dyes in each of the one or more separation channels separating a set of dye-labeled nucleic acid fragments produced from a sample, and scanning the light source across the exterior of each of the one or more separation channels in the off mode; and
detecting with a detector light emitted by each of the plurality of excited dyes in each of the one or more separation channels separating a set of dye-labeled nucleic acid fragments produced from a sample.

34. (canceled)
